(19) United States
(12) Patent Application Publication
(10) Pub. No.: US 2023/0206233 A1
(43) Pub. Date: Jun. 29, 2023

(54) IDENTIFYING SECURITY THREATS VIA USER-INPUT METRCS

(71) Applicant: Block, Inc., San Francisco, CA (US)

(72) Inventors: Todd Aument, San Francisco, CA (US); Christopher Chandler, New York, NY (US); Yoav Amit, Brooklyn, NY (US); Shane Hamilton, Minnetrista, CA (US); Dino Dai Zovi, Brooklyn, NY (US)

(21) Appl. No.: 17/564,026

(22) Filed: Dec. 28, 2021

(51) Int. Cl. G06Q 20/40; G06F 21/31

(52) U.S. Cl. CPC G06Q 20/4014; G06Q 20/4016; G06F 21/316

(57) ABSTRACT

Techniques described herein are directed to, in part, receiving input data from a computing device that includes a data capturing component; receiving, from the computing device, sensor data representing one or more characteristics associated with an interaction between a user and the data capturing component while the input data is being captured; authenticating an account associated with the user based at least in part on the input data and the one or more characteristics; and sending, to the computing device, an indication that the account of the user has been authenticated.

### TECHNICAL FIELD

In today's commerce, technology enables an array of transactions to occur remotely using applications operating on an array of different computing devices. Buyers use a mobile application operating on their devices or a point-of-sale (POS) application operating on seller devices to purchase and pay for items. In these and other instances, however, applications often request that a respective user authenticate with an account of the user prior to finalizing of a respective transaction. For instance, when a user operates an application on their mobile device to request a purchase of an item, the application may request that a user provide authentication information (e.g., a password or PIN) before a transaction is finalized. In some instances, however, fraudulent actors may gain access to this authentication information in order to complete fraudulent transactions.

### BRIEF DESCRIPTION OF THE DRAWINGS

Features of the present disclosure, its nature and various advantages, will be more apparent upon consideration of the following detailed description, taken in conjunction with the accompanying drawings.

FIG. 1 is an example environment in which a user may attempt to authenticate with a payment service by providing input data, such as a personal identification number (PIN), to an application operating on a device of the user, according to an embodiment of the present subject matter.

FIG. 2 is example input data and touch data that may be used to authenticate a user. Here, the example touch data comprises a speed at which the user inputs the input data, according to an embodiment of the present subject matter.

FIG. 3 is additional example input data and touch data that may be used to authenticate a user, according to an embodiment of the present subject matter.

FIG. 4 is example input data and touch data that may be used to authenticate a user, according to an embodiment of the present subject matter.

FIGS. 5A and 5B re processes for, in part, defining a behavioral model for authenticating a user and using the behavioral model in response to receiving a request to authenticate from a user, according to an embodiment of the present subject matter.

FIGS. 6A and 6B are example processes for, in part, determining whether to authenticate a user based on touch data received from a device, according to an embodiment of the present subject matter.

FIG. 7 is an example seller ecosystem for facilitating, among other things, techniques described herein, according to an embodiment of the present subject matter.

FIG. 8 is an example peer-to-peer payment-application ecosystem for facilitating, among other things, techniques described herein, according to an embodiment of the present subject matter.

FIG. 9 is an example data store(s) that stores, among other things, a ledger(s) associated with one or more assets for facilitating, among other things, techniques described herein, according to an embodiment of the present subject matter.

FIG. 10 is an example environment where the environments of FIGS. 7 and 8 can be integrated to enable payments at the point-of-sale using assets associated with user accounts in the peer-to-peer environment of FIG. 8, according to an embodiment of the present subject matter.

FIG. 11 is additional details associated with individual components of the ecosystem(s) described above, according to an embodiment of the present subject matter.

In the figures, the left-most digit(s) of a reference number identifies the figure in which the reference number first appears. The use of the same reference numbers in different figures indicates similar or identical items or features. The drawings are not to scale.

### DETAILED DESCRIPTION

Techniques described herein are directed to, in part, using touch data in addition to input data (such as passwords, personal identification numbers (PINs), and the like) to determine whether or not to authenticate a user. For instance, when a user operates a device to provide input data, such as a password or PIN, for the purpose of authenticating the user, the device may collect one or more metrics to indicate an interaction between the user and the device while the user provided the input data. For instance, in the example where the device includes a touchscreen display, the metrics may be determined from touch data generated during entry of the input data by the user on the touchscreen display. For instance, the metrics may include a speed at which a user tapped or swiped the input information onto the touchscreen, a size of a contact area of an implement (e.g., finger or stylus) on the touchscreen during entry of the input information, an amount of pressure of the implement on the touchscreen, an orientation of the implement, whether the user used their right or left hand, and/or other detectable touch data. This touch data may then be used, in addition to the input data, to determine whether to authenticate a user. Touch data is intended to cover data related to entry of input data. In one example, it can be related to input data entered through haptic activity, in another example, it can be related to input data entered through biometric activity, e.g., voice or body gestures.

To provide an example, a service provider, such as a payment service configured to authorize payments on behalf of respective users, may generate a behavioral model for each respective user based on one or more metrics associated with how the respective user enters input data into a device. For instance, a particular user associated with a user account at the service provider may input their PIN, password, or other authentication information several times during a configuration process. As the user inputs this authentication information, the device that is receiving this input may also generate touch data based on the physical interaction of the user with the touchscreen display. For instance, the touchscreen may generate touch data from which one or more metrics may be determined, such as how long the user remained on each character of the PIN or password, an amount of pressure associated with each input, a velocity of the implement between characters of the PIN or password, a size and orientation of the implement on the touchscreen, and the like. Upon receiving this touch data, the service provider may use this data, along with other data, to generate the behavioral model of the user. For instance, the service provider may additionally train the behavioral model based on any other number of contextual parameters, such as a geographical location typically associated with the user, transactions that the user often engages in, a purchase history of the user, merchants that the user often purchases from, applications the user often interacts with, and/or the like. The example behavioral model may comprise, in some instances, a linear model, a random forest, a neural network, and/or a model trained using any other one or more machine-learning mechanisms.

After training the behavioral model, the service provider may use this model to attempt to authenticate a user upon receiving a corresponding authentication request. For instance, envision that the user uses an application operating on a user device or a point-of-sale (POS) operating a merchant device to attempt to purchase an item from a merchant using a network-connected payment service to perform the payment transaction. During this example checkout flow, the user may be requested to enter authentication information (e.g., password or PIN or signature) that is associated with an account of the user at the payment service, that is associated with a payment instrument (e.g., credit or debit card) of the user, and/or the like. As the user enters this authentication information in the application, the device receiving the information may also generate touch data based on a physical interaction between the user (e.g., a finger of the user, a stylus operated by the user, etc.) and the device. This touch data, as described above, may be used to determine one or more metrics associated with entry of the input data, such as a tap or swipe speed of the user, an amount of pressure on the display, a size of a contact on the display, and/or the like.

After the user finishes entering the authentication information, the device may send, to the payment service, both the authentication information and the touch data. Upon receiving the authentication information and the touch data, the payment service may validate that the provided authentication information (e.g., password or PIN) is correct. If not, then then payment service may deny authentication of the user and may cancel the transaction. If, however, the authentication information is correct, then the payment service may input, to the behavioral model, one or more metrics derived from the touch data, potentially in addition to other parameters, such as an amount of the transaction, an identity of the merchant, a geolocation associated with the device the provided the data, and so forth. Further, while the above example describes the device sending the authentication information and the touch data to the payment service, in some instances the device may perform the authentication operations. For instance, the device may be configured to validate the authentication information and input the metrics derived from the touch data into the behavioral model (potentially in addition to other parameters) for receiving, from the behavioral model, an indication of whether to authenticate the user. In some instances, performing the operations on the device enables the techniques to be performed when the device is offline and is unable to communicate with the payment service.

Further, in some instances, the device may send the authentication information to the payment service such that the payment service determines whether the authentication information is correct (e.g., whether the entered PIN is correct), while the device may be configured to input the metrics determined from the touch data into the behavioral model stored at the device for receiving, from the model, an indication of whether to authenticate the user. In this example, the device may authenticate the user in response to receiving, from the payment service, an indication that the entered input information is correct and in response to receiving, from the behavioral model, that the user should be authenticated. Stated otherwise, it is to be appreciated that the authentication operations described herein may be performed at the payment service, at the client device, or across both locations.

The trained, machine-leaning, behavioral model may function to compare the inputted metrics to the metrics upon which the model has been trained and may output an indication of a correspondence between the user that is associated with the model and the user that is associated with the touch data from the inputted metrics have been derived. For instance, the behavioral model may output a score indicating a degree of correspondence, which the payment service may compare to a threshold correspondence score. If the score is greater than the threshold correspondence score, then the payment service may authenticate the user and, for instance, perform the payment transaction between the user and the merchant. In addition, in some instances the payment service may use the newly received touch data to update the behavioral model. If, however, the score is not greater than the threshold, then the payment service may decline the transaction.

Thus, and as will be appreciated, the described techniques add an additional layer of security to authentication processes to traditional techniques that are otherwise single dimensional and binary. Fraudsters may create multiple identities to coordinate fraud. This problem can be particularly pronounced if a fraudster is trying to authenticate on various services offered by a single platform. Fraudsters may take advantage of signature verification to use a stolen or counterfeit card and scribble on the touchscreen signature field. Fraudsters may have captured a PIN pad, but through mechanisms defined herein, touch event metrics differ from the real cardholder, whether at the POS or inside an application PIN screen. Fraudsters may use remote access to manipulate these services but the remote access clicks will differ from human touch events.

The techniques disclosed herein factor the provided authentication information, and contextual information, e.g., afforded by the physical manner in which the authentication information was provided to the computing device that received the authentication information. By taking this additional information into account, the techniques decreases the likelihood of success for fraudulent transactions performed using user devices, merchant devices, or the like. For instance, even if the authentication information of a particular user, such as a PIN of a user, is compromised, the techniques not only authenticate the user based on the value of an inputted PIN, but also based on whether the PIN was input in a way that is consistent with touch data on which a behavioral model that is unique to the user has been trained.

For instance, envision that a particular user consistently inputs their authentication information using their left hand, at a particular speed, with a particular amount of force, and with their finger at a particular angle, and, thus, a payment service has trained a unique behavioral model for this user based on this touch data. Envision, however, that a user purporting to be this user later requests that the payment service perform a payment transaction on behalf of the user and, in doing so, provides the correct PIN on a touchscreen of a computing device. In this example, however, envision that this computing device generates touch data that indicates that, during entry of the authentication information, the user used their right hand to enter the PIN with a different amount of pressure and time than the touch data upon which the behavioral model associated with the user has been trained. In this example, behavioral model may output a correspondence score that is less than the threshold, resulting in the payment service refraining from authenticating the user and, instead, denying the requested transaction. Thus, even though the user that requested the transaction entered the correct PIN, the techniques disallowed the transaction based on the metrics of the physical input of the PIN differing from the typical physical input of the PIN by the authenticated user.

Further, while the above example describes one scenario for one user, it is to be appreciated that the payment service or other service provider may generate individual and unique behavioral models for any number of users, and for different input techniques associated with the same user (e.g., user inputting data verbally versus touch input, or user inputting data via left hand versus right hand). Further, each of these behavioral models may be trained, using one or more complex machine-learning algorithms, on touch data and other parameters that are unique to each individual user. Thus, the techniques provide a technological solution for preventing fraudulent authentication attempts, and thus fraudulent payment transactions, in a manner that is highly scalable to protect large numbers of users at the payment service or other service provider. Further, while the above example is described with reference to a payment service determining whether to authenticate a user, it is to be appreciated that the techniques for generating and applying user-specific behavioral models may apply in any number of contexts, both for remote service providers and for applications operating on client devices. In addition, while this example is described with reference to users inputting information on touchscreen display, the data upon which the behavioral models are trained may be generated by one or more additional or different sensors, such as cameras or microphones that identify metrics associated with the physical interaction between the user and the device during entry of the authentication information, or the like.

Furthermore, in addition to determining whether or not to authenticate a user based on the generated touch data as inputted to the behavioral model, the techniques may also use this information to determine when the authentication data has been remotely generated rather than generated at the device that provided the authentication information. For instance, upon receiving a PIN from a client device, along with touch data allegedly received at the client device during entry of the PIN, the techniques may determine that touch data does not correspond to the touch data on which the behavioral model was trained and was not generated by the client device at all. Instead, the techniques may determine that the entry of the PIN comprises a fraudulent remote-access event or a set of remote-access inputs and, thus, should be denied.

In addition to determining whether or not to authenticate a user, the techniques described herein may also be utilized to identify when a same user is attempting to create or authenticate with multiple user accounts. For instance, envision that the payment service receives first authentication information associated with a first user account, along with a corresponding first set of touch data associated with the input of the first authentication data. In addition, the payment service or other service provider may receive authentication information associated with a second user account, along with a corresponding second set of touch data associated with the input of the second authentication data. In addition to attempting to authenticate each individual transaction, the payment service or other service provider may compare the first touch data to the second touch data (and, potentially, additional touch data associated with additional transactions) to determine that the touch data was provided by the same user. That is, the payment service or service provider may directly compare these touch data to determine that a difference between them is less than a threshold and, thus, that these touch events were provided by a unique user. In another example, the payment service or the service provider may input both sets of touch data into a common behavioral model and may use the respective outputs to determine that the touch events were provided by a common user. In either instance, the techniques may be used to use the touch data to determine when a same user is attempting to fraudulently authenticate with, or create, multiple user accounts.

In one implementation, user interfaces that are associated with data capturing mechanisms, such as touchscreens, microphones, antenna, or accelerator, can collect input data, such as passwords, PINs, captchas, or other authentication mechanisms. The data capturing mechanisms can provide information about the touch events that may be analyzed to create a unique fingerprint or signature of the user and to confirm granular details of a successful authentication event or to detect anomalies as input to an analysis of potential fraudulent authentication events. The user interfaces or a remote server may leverage metrics, such as finger radius, tap speed, tap interval timing, swipe speed, handedness, finger pressure, or other detectable data, to assess whether the user interfacing with the touchscreen is likely the owner of an asset or request being authenticated. An anomaly in any or all of these may provide signals about the authentication event. An asset owner may analyze metrics matched against prior metrics to signal that the person is likely the same or likely different from the person that they have associated with the asset. At a point-of-sale or similar high-risk user interface, an asset owner may identify and create rules around what qualifies as anomalous touch event, such as a dramatically different interaction with a touchscreen PIN pad, signature screen, or any other user interface. (e.g., at a POS, 100 previous touch events or signature swipes associated with an asset have been similar but a new touch event had different metrics—radius/pressure/speed etc.). In another embodiment, in an aggregated service provider environment, the asset owner may detect that a touchscreen event is anomalous from previous events purported to be from the same person. (e.g., consider P2P customers or a POS account owner with a history of consistent touch event metrics but a new anomalous measurement on a POS platform or P2P platform, respectively indicates a different person). In one implementation, the touch events can also be converted into signatures that can be accessed by third party platforms via API/SDK integrations, and vice versa. In another embodiment, in an aggregated service provider environment, the asset owner may detect that a touchscreen event is likely the same user when the user is attempting to associate with a different identity. (e.g., consider P2P customers or POS customers—conceivably buyers or sellers—where two or more different customer accounts have identical metrics on touch events, and the output of this comparison can be an input to fraud/risk signals that the same person is creating multiple accounts). In yet another embodiment, an asset owner may be able to determine that the touch events are not at all human-interface touch events, but rather mouse clicks or other functions that may be attributed to a remote access event.

Additional benefits and efficiencies are described throughout this disclosure.

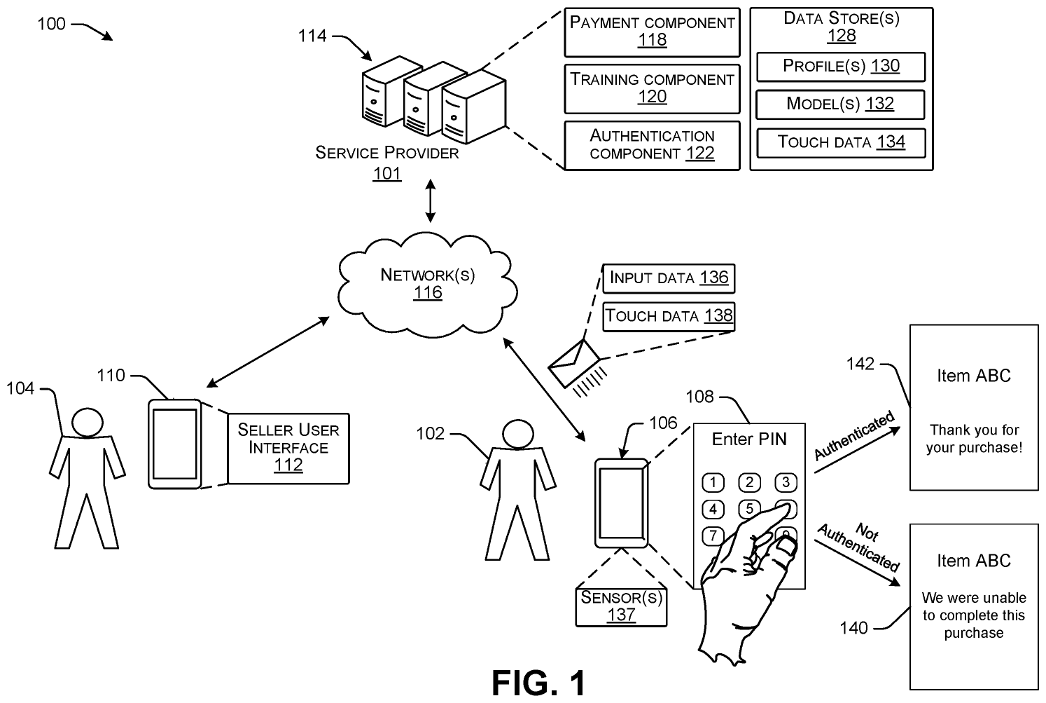

FIG. 1 illustrates an example environment 100 associated with a service provider 101, such as a payment service, that is configured to authenticate users based on primary data, such as input data (e.g., PINs, passwords, etc.), and secondary data, such as sensor data or more specifically touch data indicating metrics associated with capturing of the input data. FIG. 1 includes a buyer 102 and a seller 104 conducting a transaction, however the buyer 102 and seller 104 can also be a payer or a payee, or an artist or a fan, respectively. The buyer 102 can be an entity that purchases, leases, borrows, or otherwise acquires items from sellers, such as the seller 104. The seller 104 can be an entity that sells, leases, gives, or otherwise provides items to buyers, such as the buyer 102. “Item,” as used herein, can be used to describe a good or a service. Reference is made herein to requested and rendered services. In some examples, a service can require multiple goods and/or other services for fulfillment (e.g., performance thereof, completion, etc.). Further, while requested and rendered services are described, in additional or alternative examples, techniques described herein can relate to requested and rendered goods.

In at least one example, the buyer 102 can interact with a buyer computing device 106, for example, via a buyer user interface 108. The buyer user interface 108 can enable the buyer 102 to access services of the service provider 101 and/or otherwise interact with the service provider 101. In some examples, the buyer user interface 108 can be presented via an application, such as a mobile application or desktop application, which can be provided by the service provider 101 or which can be an otherwise dedicated application. In some examples, the application can be an instance or versioned instance of the application, which can be downloaded from an application store. In some examples, the buyer user interface 108 can be accessible via a web browser, a progressive web application, an instant application (e.g., a portion of an application that can correspond to a particular, discrete functionality (or functionalities) and that can be downloaded to provide a fast, lightweight user experience), and/or the like. As described in detail below, the buyer user interface 108 may enable the buyer 102 to request to purchase an item and to engage in a checkout flow, which may include providing authentication information, as illustrated in FIG. 1.

As described above, in some examples, the buyer user interface 108 can be presented via an application provided by the service provider 101. In such an example, such an application can be a hub for buyer interactions with the service provider 101. That is, the buyer 102 can access one or more services of the service provider 101 via the application. As an example, the buyer 102 can access rewards, loyalty, invoices (e.g., paid/unpaid), receipts, orders (e.g., fulfilled/unfulfilled), account information (e.g., funds associated therewith), and the like. In at least one example, the buyer 102 can request a service via the buyer user interface 108. In some examples, such a request can be associated with a contract, a message, an appointment, and/or the like. In some examples, such a request can be associated with data captured via one or more data capturing services. Such data can include text data, video data, image data, audio data, combinations of the foregoing, and/or the like. In some examples, a request for a service can be associated with a request for an estimate to perform the requested service. In one implementation, the buyer user interface 108 can be presented on a point-of-sale device associated with the seller 104, e.g., at a brick-and-mortar location of the seller 104.

In at least one example, the seller 104 can interact with a seller computing device 110, for example, via a seller user interface 112. The seller user interface 112 can enable the seller 104 to access services of the service provider 101. In some examples, the seller user interface 112 can be presented via an application, such as a mobile application or desktop application, which can be provided by the service provider 101 or which can be an otherwise dedicated application. In some examples, the application can be an instance or versioned instance of an application, which can be downloaded from an application store. In some examples, the seller user interface 112 can be associated with multiple user interfaces, which in some examples, can each correspond with individual of the services available via the service provider 101. For example, the seller 104 can access payment processing services via a payment processing user interface, an invoice service via an invoice user interface, and so on. In some examples, such individual services can be accessible via the same or different applications. In some examples, the seller user interface 112 can be accessible via a web browser, a progressive web application, an instant application, and/or the like. In examples where individual services are availed via individual user interfaces, each of the user interfaces can be presented via a web browser, a progressive web application, an instant application, and/or the like. In some instances, the seller user interface 112 may, like the buyer user interface 108, enable the buyer 102 to request to purchase an item and to engage in a checkout flow, which may include providing authentication information.

As described above, in some examples, the seller user interface 112 can be presented via an application provided by the service provider 101. In such an example, such an application can be a hub for seller interactions with the service provider 101. That is, the seller 104 can access one or more services of the service provider 101 via the application. In at least one example, the buyer 102 can interact with the buyer user interface 108 and/or the seller 104 can interact with the seller user interface 112 via touch input, spoken input, or any other type of input. Examples of GUIs are described below.

While a single buyer 102 and buyer computing device 106 are illustrated in FIG. 1, in practice, the environment 100 can comprise tens, hundreds, or thousands of buyers and buyer computing devices. Similarly, while a single seller 104 and seller computing device 110 are illustrated, in practice, the environment 100 can comprise tens, hundreds, or thousands of sellers and seller computing devices.

In at least one example, the environment 100 can include server computing device(s) 114 associated with the service provider 101, which can be in communication with the buyer computing device 106 and/or the seller computing device 110 via network(s) 116 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). In at least one example, the server computing device(s) 114 can be associated with the service provider 101, e.g., “payment-processing service” described herein. Other examples of service provider 101 can be “music-streaming service,” “a lending service,” and so on. In some examples, actions attributed to the service provider 101 can be performed by the server computing device(s) 114. However, in other examples, actions attributed to the service provider can be performed by an agent of the service provider 101 (e.g., an employee, an independent contractor, etc.). The server computing device(s) 114 can include one or more functional components including, but not limited to,

The server computing device(s) 114 can also be associated with data store(s) 128, which can store data including but not limited to profile data 130, one or more trained machine-learning models 132, and sensor data, e.g., touch data 134 received during authentication requests, as discussed below. This data is described below with reference to operation of the server computing devices 114.

In at least one example, the server computing device(s) 114 can be associated with one or more APIs to facilitate communications between the buyer computing device 106, the seller computing device 110, components of the server computing device(s) 114, and/or one or more third-party server(s). In at least one example, the server computing device(s) 114 may also provide a payment component 118, a training component 120, and an authentication component 122. In at least one example, the payment component 118 can, among other things, process transactions for sellers associated with the service provider 101, facilitate peer-to-peer (P2P) payment transactions between users, allow purchase of merchandise, items or services, or the like. In at least one example, the payment component 118 can transmit requests (e.g., authorization, capture, settlement, etc.) to payment service server computing device(s) (which can be associated with the third-party server(s)) to facilitate transactions between sellers and buyers, such as the seller 104 and the buyer 102. The payment component 118 can communicate the successes or failures of the transactions to the seller computing device 110. In at least one example, the payment component 118 can generate and/or receive transaction data associated with transactions processed on behalf of the seller 104 (and/or other, different sellers as described below) that utilize the service provider 101 for processing transactions. In at least one example, such transaction data can include payment data, which can be obtained from a reader device associated with the seller computing device 110 or otherwise provided to the service provider 101, user authentication data, purchase amount information, point-of-purchase information (e.g., item(s) purchased, date of purchase, time of purchase, parties to the transaction, etc.), etc. In some examples, the transaction data can be stored in the data store(s) 128.

While the payment component 118 may facility transactions between buyers and sellers, the training component 120 may train one or more models 132 using received touch data, potentially along with other behavioral data associated with respective buyers, such as the buyer 102. For instance, the training component 120 may train a model that is unique to the buyer 102 based on touch data indicating one or more metrics associated with interaction of the buyer 102 with a client device to provide authentication information, such as how the buyer 102 enters their PIN or captcha on the illustrated buyer interface 108. For instance, the training component 120 may receive touch data indicating information, such as a tap speed of the finger of the buyer 102 as the buyer 102 enters their PIN, the amount of pressure on a touchscreen as the buyer 102 enters their PIN, the orientation of the finger of the buyer 102 as the buyer 102 enters the PIN, the size and shape of the contact area of the finger of the buyer 102 as the buyer 102 enters the PIN, and any similar or different data indicating how the user physically interacts with the interface 102 and/or the device 106 when inputting the PIN or other authentication information. In one implementation, the buyer and/or seller registers for the service that collects touch data for authentication purposes, or provides explicit consent to collecting and using touch data. Further, and as discussed above, touch data is intended to cover data related to entry of input data. In one example, it can be related to input data entered through haptic activity, in another example, it can be related to input data entered through biometric activity, e.g., voice or body gestures. Thus, while this example describes touch data, it is to be appreciated that other implementations may use additional or different sensor data, such as sensor data generated by sensor(s) 137, such as a camera, a microphone, an accelerometer, a gyroscope, an antenna, or a combination thereof.

In addition to training a model for the buyer 102 based on the touch data, the training component 120 may also input, to the model as training data, additional, non-touch data associated with the buyer 102. For instance, the training component 102 may input, as training data to the model, an indication of a purchase history of the buyer 102, geographical location(s) associated with the buyer 102, merchants frequented by the buyer 102, other devices or network identifiers frequently associated within a proximity of the buyer 102 during authentication events (i.e. determined by local wireless networks within range of buyer 102, other devices detected by near field communication mechanisms) and/or any other similar or different data that may be used to generate a model that is unique to the buyer 102 and may be used to later identify the buyer. As described above, any one or more machine-learning mechanisms may be used to generate the model for the buyer 102, such as a linear model, a random forest, gradient boosting trees, a neural network, and/or the like. The training data can also provide context that can be used to connect data points to the same user (e.g., buyer 102). For example, context, such as weather, time of the day, geographical location, etc., can be used to explain the anomalies in two data points appearing to come from the same user.

In some instances, the training component 120 may request that the buyer 102 provide configuration data in the form of touch to train the model for the user. That is, the training component 120 may send, to the buyer user interface 108 or another user interface, a request that the buyer 102 enter their PIN or other authentication information several times. The client device may then generate and send the touch data, which the training component may use to train the model. In other instance, the training component 120 may “learn” the model over time by storing received touch data and using the received touch data to build a model that is unique to the user.

Regardless of whether the training component 120 requests that the buyer 102 engage in a defined configuration process or whether the training component 120 builds the model over the course of authentication requests from the buyer 102, when the model is created for the buyer 102 the authentication component 122 may use the model as part of attempting to authenticate the buyer 102 upon receiving an authentication request. FIG. 1, for instance, illustrates an example where the buyer 102 operates the buyer interface 108 to provide authentication information, or input data 136. In addition, while the buyer 102 enters the input data 136, one or more sensors 137 (or “data capturing components”) of the buyer device 106 may generate sensor data (or “data capturing component data”), which may be used in addition to the input data 136 to make an authentication decision. In some instances, the sensor data comprises touch data 138 generated a touch sensor (e.g., a touchscreen display) of the buyer device 106, while in other instances the sensor(s) 137 may additionally or alternatively comprise camera(s), microphone(s), accelerometer(s), gyroscope(s), or the like.

In the illustrated example, the buyer device 106 includes a touchscreen that generates the touch data 138 while the buyer 102 enters the input data 136, and the buyer device 106 sends the input data 136 along with corresponding touch data 138 to the authentication component 122 as part of an authentication request. For instance, the buyer 102 may operate the buyer interface 108 as part of a checkout flow for purchasing an item, as part of a request to send or receive money on a peer-to-peer payment application, or to perform any other process that includes an authentication of the buyer 102. Therefore, the application executing on the buyer device 106 may be configured to send, to the authentication component 122 and as part of an authentication request, the input data 136 (in this instance comprises the PIN of the buyer 102) and the touch data 138 indicating the physical interaction between the buyer 102 and the touchscreen of the buyer device 106.

Upon receiving the authentication request from the buyer 102, the authentication component 122 may first identify, from the profile data 130, the user account associated with the buyer 102. For instance, the authentication component 122 may use an identifier of the buyer 102 to identify the user account and, thereafter, may compare the received input data 136 (e.g., the PIN) to authentication information (e.g., a PIN, password, captcha or the like) stored at the server computing device(s) 114 in association with the user account. That is, the authentication component 122 may compare the received authentication information with the stored authentication information to determine whether the information matches. If not, then the authentication component 122 may deny the authentication request and any corresponding requested transaction as illustrated at another buyer interface 140.

If the authentication information matches, however, then the authentication component 122 may input the touch data 138 into the trained machine-learning model associated with the user account of the buyer 102. For instance, the authentication component 122 may derive one or more metrics from the touch data 138 and may input these metrics as feature data into the behavioral model trained for the buyer 102. The model may output a score indicating a level of correspondence between the touch data 138 and the touch data on which the model has been trained. The authentication component 122 may then compare this score to a threshold and, if the score is less than the threshold, may output an indication that the authentication has been denied, such as the buyer interface 140. In addition, the authentication component 122 may send, to a merchant device or other device associated with a currently requested transaction, an indication of a potential fraud attempt. If, however, the score is greater than a threshold, then the authentication component 122 may authenticate the buyer 102 and output another buyer interface 142 indicating that the buyer 102 has been authenticated. In addition, the server computing device(s) 114 may perform any corresponding transaction. For instance, the payment component 118 may provide payment to a merchant or the like.

In addition to the above example, the techniques described herein may apply equally to in the context of a peer-to-peer (P2P) payment application. For instance, the buyer interface 108 may comprise an interface provided by the P2P application when a user intends to send or receive payment to another user. For instance, in response to a user, such as the illustrated buyer 102, requesting to send or receive a payment to or from another user, the P2P application may present the interface 108 requesting that the user enter their PIN or other authentication information. Again, the device may generate and send both the input data 136 and the touch data 138 to one or more computing devices, such as to one or more of the servers 114 that is configured to authenticate the transaction and move the funds associated with the P2P payment request after successfully authenticating the request. The server(s) 114 may then perform the operations of the authentication component 122 for determining whether to authenticate the P2P payment transaction based on both the input data 136 and the touch data 138. Similar to the above, upon the server(s) 114 determining that the P2P payment transaction is authenticated and approved, the server(s) 114 may cause the device 106 to present another user interface (UI) indicating that the P2P payment has been approved. In response to the server(s) 114 determining that the P2P payment application is not authenticated or approved, the server(s) 114 may cause the device to present a UI indicating that the P2P payment has not been approved.

Further, while the above examples are described with reference to purchasing items or performing P2P payment transactions, the techniques for authenticating a user based on both the input data 136 and the touch data 138 may be performed in other contexts. For instance, these techniques may be performed for any sort of user sign process, such as a user signing into an application, an ATM machine, a device, or the like. In addition, while the illustrated example describes generating input data 136 in the form of a PIN, it is to be appreciated that this input data 136 may comprise any other sort of data, such as a user password, a username, or the like. In some instances, for example, a user may be authenticated using other means, and the described techniques may be used to supplement these authentication techniques. To provide an example, envision that a user is authenticated using facial recognition or other biometric recognition, but the user still inputs data to the device during a requested transaction. During entry of this data, the device may generate the touch data 138 and send the touch data to the computing devices 114, the payment network server, or the like. The devices or server may then analyze the touch data 138 using the techniques described above with reference to the authentication component 122 to determine whether to approve the requested transaction. Stated otherwise, it is to be appreciated that the described techniques may be implemented in instances where the user is authenticated via different means, or authentication is not required. Here, the touch data 138 may still be analyzed as described above to determine whether to approve a requested transaction.

As described above, the training component 120 may generate unique behavioral models for individual buyers, such as the buyer 102, and the authentication component 122 may use these behavioral models to determine whether or not to authenticate buyers, such as the buyer 102. As described, individual models may be trained one, and subsequent authentication decisions may be based on, both the provided input data (e.g., PIN, password, etc.), touch data associated with the input of the input data, and additional data stored in the buyer profile data 130. The buyer profile data 130 may include any sort of data associated with respective buyers, such as the buyer 102. For instance, such buyer data can include, but is not limited to, buyer information (e.g., name, phone number, address, banking information, etc.), buyer preferences (e.g., learned or buyer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), loan information associated with the buyer (e.g., previous loans made to the buyer, previous defaults on said loans, etc.), invoice information associated with the buyer (e.g., invoices received, paid, incentives associated therewith, etc.), estimate information associated with the buyer (e.g., estimates requested, estimates received, estimates accepted, estimates converted into invoices, etc.), workflow information associated with the buyer (e.g., workflows in progress, workflows completed, etc.), risk information associated with the buyer (e.g., indications of risk, instances of fraud, chargebacks, etc.), appointments information (e.g., previous appointments, upcoming (scheduled) appointments, timing of appointments, lengths of appointments, etc.), payroll information (e.g., employers, payroll frequency, payroll amounts, etc.), reservations information (e.g., previous reservations, upcoming (scheduled) reservations, reservation duration, interactions associated with such reservations, etc.), buyer service information, etc.

In addition, while the profile data 130 is described with reference to the buyer 102, this profile data 130 may additionally or alternatively represent data associated with the seller 104 or other sellers. Seller profile data can include, for instance, any data associated with sellers. For instance, a seller profile can store, or otherwise be associated with, information about a seller (e.g., name of the seller, geographic location of the seller, operating hours of the seller, employee information, etc.), a seller category classification (MCC), item(s) offered for sale by the seller, hardware (e.g., device type) used by the seller, transaction data associated with the seller (e.g., transactions conducted by the seller, payment data associated with the transactions, items associated with the transactions, descriptions of items associated with the transactions, itemized and/or total spends of each of the transactions, parties to the transactions, dates, times, and/or locations associated with the transactions, etc.), invoice information associated with the seller (e.g., invoices sent, paid, incentives associated therewith, etc.), estimate information associated with the seller (e.g., estimates sent, estimates converted into invoices, etc.), workflow information associated with the seller (e.g., workflows in progress, workflows completed, etc.), loan information associated with the seller (e.g., previous loans made to the seller, previous defaults on said loans, etc.), risk information associated with the seller (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations information (e.g., previous reservations, upcoming (scheduled) reservations, interactions associated with such reservations, etc.), inventory information, buyer service information, etc. The seller profile can securely store bank account information as provided by the seller. Further, the seller profile can store payment information associated with a payment instrument linked to an account of the seller that is maintained by the service provider 101.

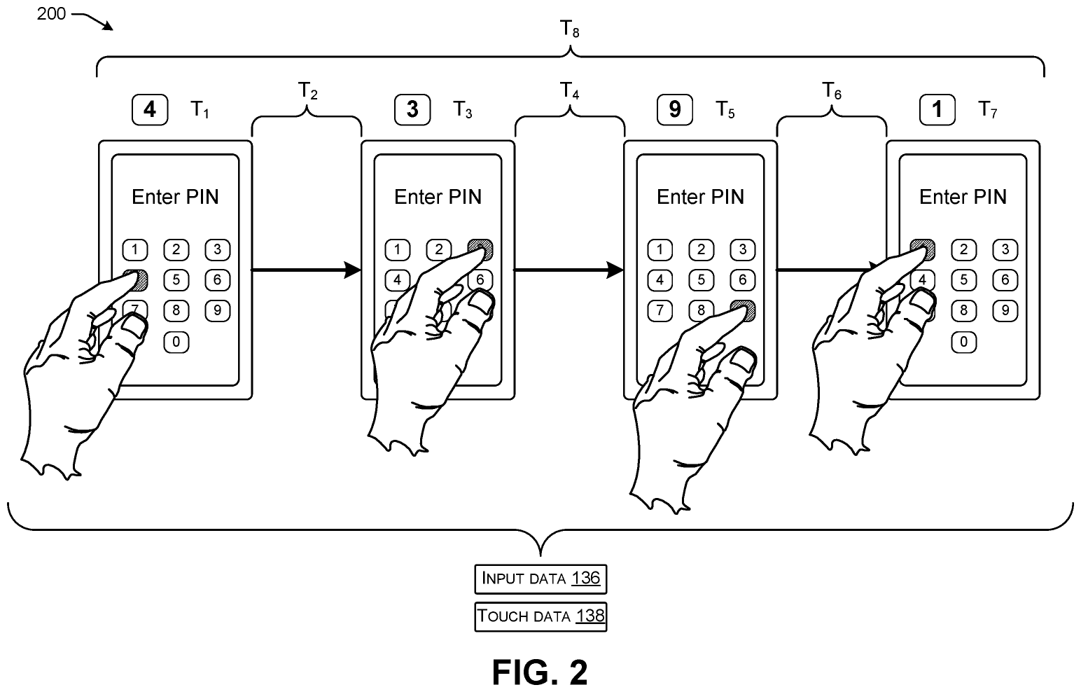

FIG. 2 is an example flow diagram 200 of capturing input data 136 and sensor data (in this instance touch data 138) that may be used to authenticate a user, according to an embodiment of the present subject matter. According to one embodiment, the example buyer 102 of FIG. 1 may provide an authentication request along with input data 136. Here, the user provides the input data 136 in the form of the PIN, although any other type of authentication information may be used. For example, the input data 136 can take the form of biometric information, such as voice information or gestures, e.g., to support accessibility. In this example of haptic data, the buyer 102 enters the PIN number “4391” through a series of four inputs on the touchscreen display of the buyer device 106, the seller device 110, or another device. While the buyer 102 enters this PIN, the device may generate and store touch data 138 indicating an amount of time that the buyer placed their finger on the first character of the PIN (“T₁”), an amount of time between the buyer placing their finger on the first character of the PIN and a second character of the PIN (“T₂”), an amount of time that the buyer placed their finger on the second character of the PIN (“T₃”), an amount of time between the buyer placing their finger on the second character of the PIN and a third character of the PIN (“T₄”), an amount of time that the buyer placed their finger on the third character of the PIN (“T₅”), an amount of time between the buyer placing their finger on the third character of the PIN and a fourth character of the PIN (“T₆”), an amount of time that the buyer placed their finger on the fourth character of the PIN (“T₇”), and an overall amount of time taken to enter the entire PIN (“T₈”).

As illustrated, this time-based information may be stored by the device as part of or an entirety of the touch data 138, and may be sent to the server computing device(s) 114. During the training phase, the training component 120 may use the received touch data 138 to train a model for the buyer. In addition to the touch data, in some embodiments, contextual data such as weather information, location information, or can also be collected to provide context to the touch data. For example, any anomalies in the touch data during entry of input data can be explained or contextualized with the context data, such as rainy weather or data entered while in a moving car. During the authentication phase, the authentication component 122 may use the touch data 138 (along with the input data 136 and potentially additional data) to determine whether to authenticate the buyer 102. When using context data, the authentication component 122 may use the touch data 138 (along with the input data 136 and additional data, such as context data) to determine whether to authenticate the buyer 102 if the data points correspond to the buyer 102 or substantially similar buyer 102.

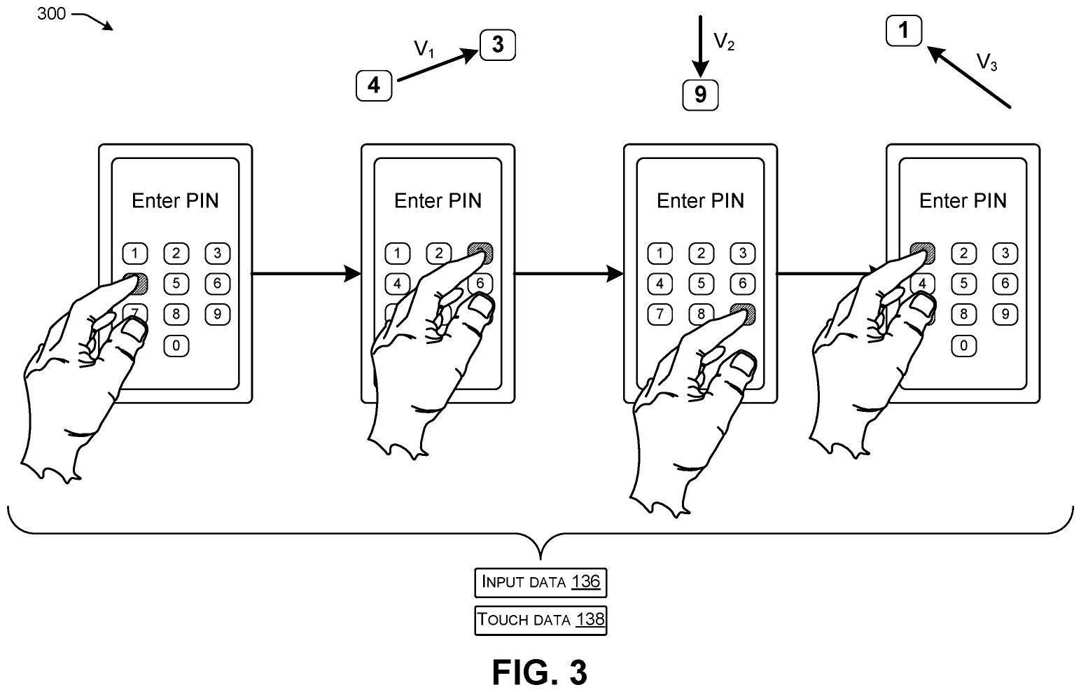

FIG. 3 is another example 300 of capturing input data 136 and sensor data (in this instance touch data 138) that may be used to authenticate a user, according to an embodiment of the present subject matter. According to one embodiment, the example buyer 102 of FIG. 1 may provide an authentication request along with input data 136. The user may provide the input data 136 in the form of the PIN, although any other type of authentication information may be used. For example, the input data 136 can take the form of biometric information, such as voice information or gestures, e.g., to support accessibility. In this example, the buyer 102 enters the PIN number “4391” through a series of four inputs on the touchscreen display of the buyer device 106, the seller device 110, or another device. While the buyer 102 enters this PIN, the device may generate and store touch data 138 indicating a velocity associated with a swiping gesture of the buyer 102 from the first character of the PIN to the second character of the PIN (“V₁”), a velocity associated with a swiping gesture of the buyer 102 from the second character of the PIN to the third character of the PIN (“V₂”), and a velocity associated with a swiping gesture of the buyer 102 from the third character of the PIN to the fourth character of the PIN (“V₄”). As illustrated, this velocity-based information may be stored by the device as part of or an entirety of the touch data 138, and may be sent to the server computing device(s) 114. During the training phase, the training component 120 may use the received touch data 138 to train a model for the buyer. In addition to the touch data, in some embodiments, contextual data such as weather information, location information, or can also be collected to provide context to the touch data. For example, any anomalies in the touch data during entry of input data can be explained or contextualized with the context data, such as rainy weather or data entered while in a moving car. During the authentication phase, the authentication component 122 may use the touch data 138 (along with the input data 136 and potentially additional data) to determine whether to authenticate the buyer 102. When using context data, the authentication component 122 may use the touch data 138 (along with the input data 136 and additional data, such as context data) to determine whether to authenticate the buyer 102 if the data points correspond to the buyer 102 or substantially similar buyer 102.

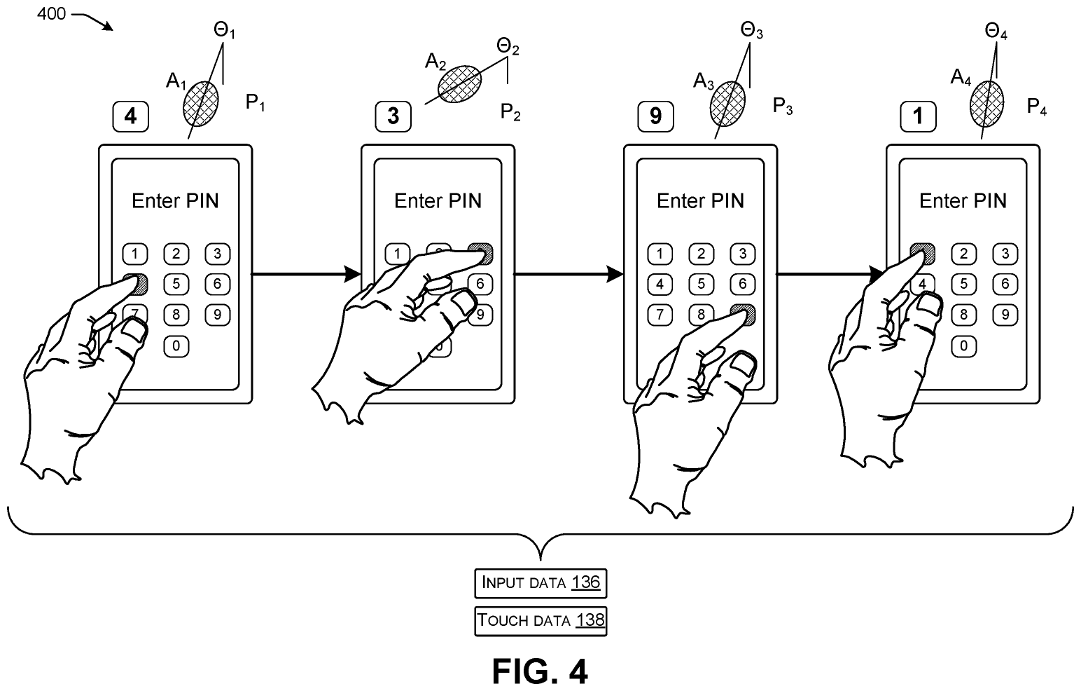

FIG. 4 is an example flow diagram 400 of capturing input data 136 and sensor data (in this instance touch data 138) that may be used to authenticate a user, according to an embodiment of the present subject matter. According to one embodiment, the example buyer 102 of FIG. 1 may provide an authentication request along with input data 136. Here, the user again provides the input data 136 in the form of the PIN, although any other type of authentication information may be used. For example, the input data 136 can take the form of biometric information, such as voice information or gestures, e.g., to support accessibility. In this example, the buyer 102 enters the PIN number “4391” through a series of four inputs on the touchscreen display of the buyer device 106, the seller device 110, or another device. While the buyer 102 enters this PIN, the device may generate and store touch data 138 indicating a shape and size of an area of the implement (e.g., finger or stylus) of the buyer on the touchscreen display during input of the first character of the PIN (“A₁”), an orientation (e.g., angle or handedness) of the implement on the touchscreen display during input of the first character of the PIN (Θ₁), an amount of pressure of the implement on the touchscreen display during input of the first character of the PIN (P₁), a shape and size of an area of the implement of the buyer on the touchscreen display during input of the second character of the PIN (“A₂”), an orientation of the implement on the touchscreen display during input of the second character of the PIN (Θ₂), an amount of pressure of the implement on the touchscreen display during input of the second character of the PIN (P₂), a shape and size of an area of the implement of the buyer on the touchscreen display during input of the third character of the PIN (“A₃”), an orientation of the implement on the touchscreen display during input of the third character of the PIN (Θ₃), an amount of pressure of the implement on the touchscreen display during input of the third character of the PIN (P₃), a shape and size of an area of the implement of the buyer on the touchscreen display during input of the fourth character of the PIN (“A₄”), an orientation of the implement on the touchscreen display during input of the fourth character of the PIN (Θ₄), and an amount of pressure of the implement on the touchscreen display during input of the fourth character of the PIN (P₄),

As illustrated, this information may be stored by the device as part of or an entirety of the touch data 138, and may be sent to the server computing device(s) 114. During the training phase, the training component 120 may use the received touch data 138 to train a model for the buyer. In addition to the touch data, in some embodiments, contextual data such as weather information, location information, or can also be collected to provide context to the touch data. For example, any anomalies in the touch data during entry of input data can be explained or contextualized with the context data, such as rainy weather or data entered while in a moving car. During the authentication phase, the authentication component 122 may use the touch data 138 (along with the input data 136 and potentially additional data) to determine whether to authenticate the buyer 102. When using context data, the authentication component 122 may use the touch data 138 (along with the input data 136 and additional data, such as context data) to determine whether to authenticate the buyer 102 if the data points correspond to the buyer 102 or substantially similar buyer 102.

While FIGS. 2-4 illustrate example input data 136 in the form of a PIN, it is to be appreciated that any other type of input data 136 may be used. For example, the input data in some embodiments can be a signature and PIN, signature alone, name, voice instruction, or body gestures (e.g., facial gestures), and the like. Similarly, while FIGS. 2-4 illustrate example touch data 138, it is to be appreciated that any other similar or different touch data 138, or combination of touch data 138, may be used to train behavioral models and thereafter authenticate buyers using the behavioral models. In some instances, other sensor data (e.g., generated by a camera, microphone, or the like) may additionally or alternatively be used to train the behavioral models, Further, it is to be appreciated that the graphical user interfaces (GUIs) described above with reference to FIGS. 2-4 are merely illustrative and non-limiting and include example user-interface elements. A user interface element can be text, an image, an icon, a picture, a control, or any other element that can be used by a user to interact with the user interface. In some examples, a user interface element can be associated with an actuation mechanism, such that the user interface element is selectable or otherwise interactable, and can be surfaced in an interstitial notification, as a pop-up notification, as a widget, and so on. As described above, the GUIs are provided for illustration and can be associated with additional or alternative data, which can be presented in additional or alternative configurations. That is, the GUIs illustrated in FIGS. 2-4 should not be construed as limiting.

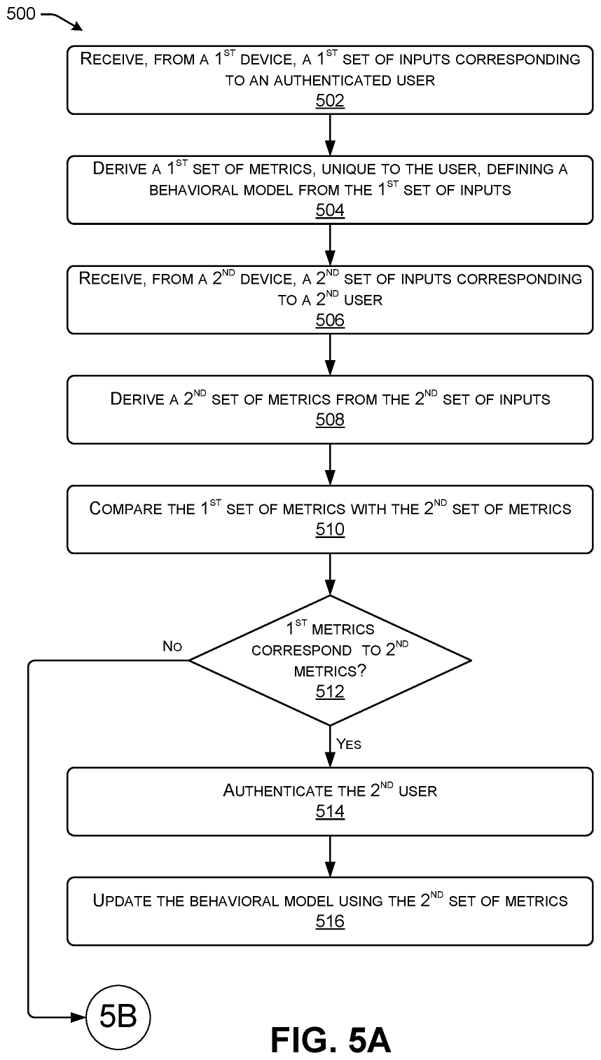

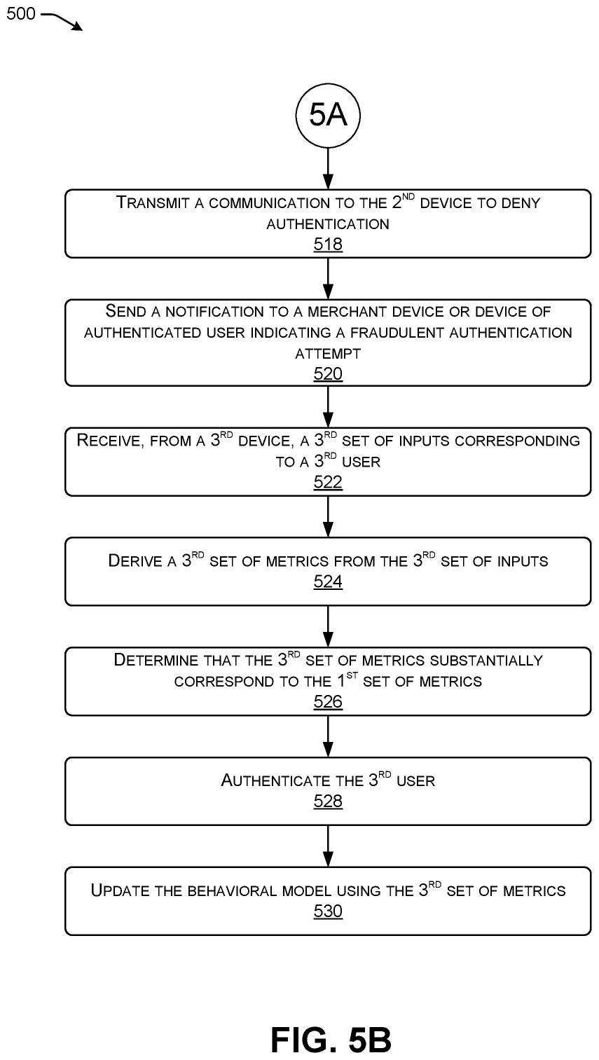

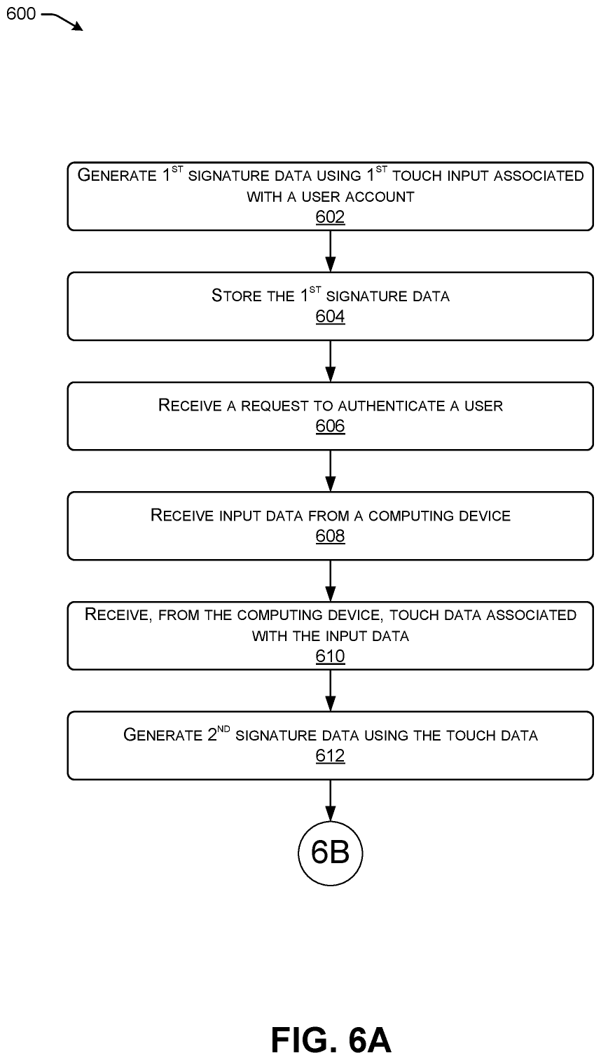

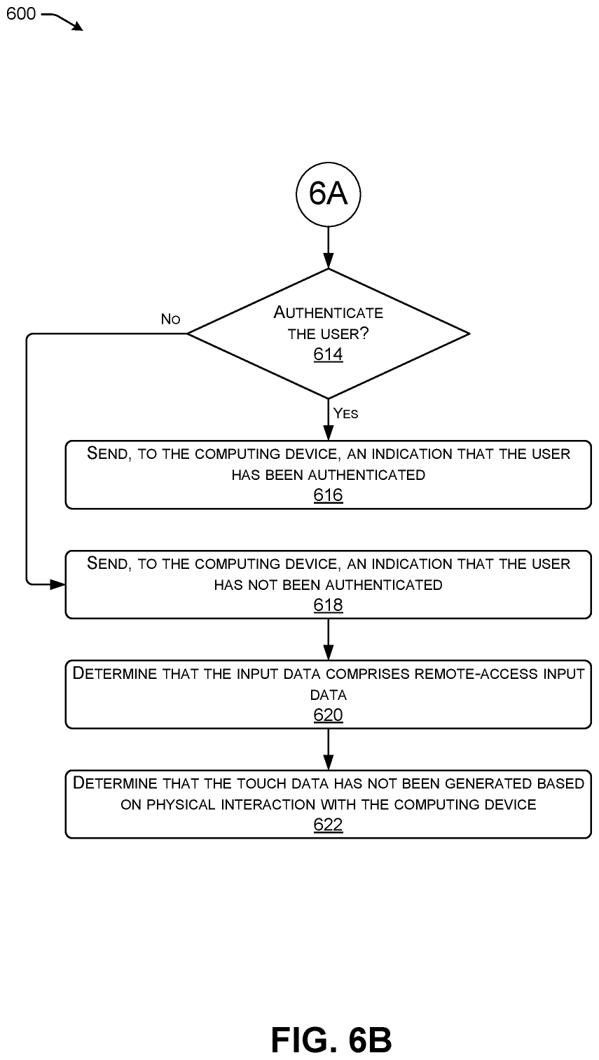

FIGS. 5A and 5B and 6A and 6B are flowcharts showing example methods as described herein. The methods illustrated in these figures may be described with reference to components of FIG. 1 for convenience and ease of understanding. However, the methods illustrated in these figures are not limited to being performed using components described in FIG. 1, and such components are not limited to performing the methods illustrated in FIGS. 5A and 5B and 6A and 6B.

The methods 500 and 600 are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Computer-executable instructions include routines, programs, objects, components, data objects, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods 500 and 600 can be combined in whole or in part with each other or with other methods.

Referring to FIG. 5A, the method 500 includes, at an operation 502, the training component 120 or other component receiving, from a first computing device, a first set of inputs corresponding to an authenticated user. This first set of inputs may include input data and touch data. Additionally or alternatively, the first set of inputs may also include context data derived from the circumstances in which the touch data or input data is provided. In one example, the first set of inputs is collected based on touch data generated by the first computing device while the authenticated users entered input data, such as a password, PIN, username, or any other type of data. For example, a user interface captures such set of inputs, packages in a format suitable for the service provider 101, and sends these inputs to the service provider 101 over a network. In one implementation, the first user may provide the first set of inputs at the time of account registration. Further, and as described above, touch data is intended to cover data related to entry of input data. In one example, it can be related to input data entered through haptic activity, in another example, it can be related to input data entered through biometric activity, e.g., voice or body gestures.

The method 500 also includes, at an operation 504, the training component 120 or other component deriving a first set of metrics defining a behavioral model from the first set of inputs, the first set of metrics unique to the authenticated user. The first set of metrics may comprise any of the metrics described above or otherwise, such as a tap speed of the user, a touch area of an implement (e.g., finger) on the touchscreen, an angle of an implement (e.g., stylus, pen or finger), an amount of pressure on the touchscreen, or the like.

The method 500 also includes, at an operation 506, receiving, at the service provider 101 and from a second computing device, a second set of inputs corresponding to a second user, who may or may not be the first user. For instance, this operation may comprise receiving, from the same or a different computing device, touch data provided by the same or a different user when entering input data, such as a password, PIN, username, or the like. The method 500 also includes, at an operation 508, the authentication component 122 or other component deriving a second set of metrics from the second set of inputs. This second set of metrics may comprise any of the metrics described above or otherwise, such as a tap speed of the user, a touch area of an implement (e.g., finger) on the touchscreen, an angle of an implement (e.g., stylus, pen or finger), an amount of pressure on the touchscreen, or the like. In one implementation, the second user may provide the second set of inputs in response to a transaction, e.g., with a merchant, or in response to a peer-to-peer transaction, and the like.

The method 500 also includes, at an operation 510, the authentication component 122 or other component comparing the first set of metrics with the second set of metrics. For instance, this operation may comprise comparing metrics derived from the first user and the second user (e.g., tap speed to tap speed), inputting the second set of metrics into a machine-learned model that has been trained using the first set of metrics, or the like. The method 500 also includes, at an operation 512, the authentication component 122 or other component determining whether the second set of metrics does substantially corresponds with the first set of metrics. This may comprise determining whether the model outputs an indication that the sets of metrics are substantially similar to one another, determining whether an amount of different between a direct comparison of the inputs is less than a threshold, or the like. If it is determined that the first and second sets of metrics substantially correspond to one another, then at an operation 514 the method 500 includes authenticating the second user and, at an operation 516, updating the behavioral model using the second set of metrics.

If the first and second metrics do not correspond to one another, however, then the method 500 continues at FIG. 5B, which includes, at an operation 518, the authentication component 122 or other component identifying a deviation from the behavioral model for the authenticated user and transmitting a first communication to the second computing device to deny authentication to the second user. In some instances, rather than deny the authentication, the authentication component 122 or other component may determine context data associated with entry of the second set of inputs and may determine that the identified deviation is attributable to this determined context data. For example, the deviation may be explained or contextualized with the context data, such as rainy weather or data entered while in a moving car. In these instances, the authentication component 122 or other component may determine to at least provisionally approve the authentication request, potentially subject to the second user providing another way to verify their identity.

In some instances, meanwhile, the method 500 also includes at an operation 520 sending a second communication to a merchant device associated with a merchant account indicating a fraudulent authentication attempt. For instance, if the authentication component 122 or other component has identified the deviation from the behavioral model and the context data does not support a provisional authentication of the user, then the authentication component 122 or other component may send an indication of a potential fraudulent sign-in attempt or the like.

The method 500 also includes, at an operation 522, receiving, at the service provider 101 and from a third computing device, a third set of inputs corresponding to a third user, who may or may not be the first user. For instance, this operation may comprise receiving, from the same or a different computing device, touch data provided by the same or a different user when entering input data, such as a password, PIN, username, or the like. The method 500 also includes, at an operation 524, the authentication component 122 or other component deriving a third set of metrics from the third set of inputs. This third set of metrics may comprise any of the metrics described above or otherwise, such as a tap speed of the user, a touch area of an implement (e.g., finger) on the touchscreen, an angle of an implement (e.g., stylus, pen or finger), an amount of pressure on the touchscreen, or the like. In one implementation, the second user may provide the second set of inputs in response to a transaction, e.g., with a merchant, or in response to a peer-to-peer transaction, and the like.

The method 500 also includes, at an operation 526 the authentication component 122 or other component comparing the third set of metrics with the first set of metrics and determining that the first and third sets of metrics substantially correspond to one another. For instance, this operation may comprise comparing metrics derived from the first user and the third user (e.g., tap speed to tap speed), inputting the second set of metrics into a machine-learned model that has been trained using the first set of metrics, or the like. In response to determining that that the first and third sets of metrics substantially correspond to one another, then at an operation 528 the method 500 includes authenticating the third user and, at an operation 530, updating the behavioral model using the third set of metrics.

FIG. 6 is a flowchart showing an example method for determining whether to authenticate a user based on touch data received from a device. At an operation 602, first signature data is generated using at least previously received first touch data associated with the account of the first user. For instance, as part of an enrollment process, a user may be asked to enter certain input data. As the user enters the input data, a touch sensor of a computing device on which the user enters the data, may generate the first touch data based on any type of metrics, such as a tap speed of the user, a touch area of an implement (e.g., finger) on the touchscreen, an angle of an implement (e.g., stylus, pen or finger), an amount of pressure on the touchscreen, or the like. This first touch data may then be used to generate first signature data. In some instances, the first signature data is generated from multiple touch events and, thus, is generated using the first touch data as well as prior touch data generated while the same user previously entered the input data. For instance, as part of an enrollment process, the computing device may request that the user enter their input data (e.g., PIN) five different times on the touchscreen display. The touchscreen may then generate five different touch data, each associated with a respective entry of the input data. The first signature data may then be generated from the first, second, third, fourth, and fifth touch data, such as an average of these five touch data.

The method 600 includes, at an operation 604, storing the first signature data, such as storing the first signature data in association with a profile of an account of the user, training a model customized to the user based on the first signature data and storing an association between the model and a profile of the user, or the like. In some instance, the training component 120 or another component may perform the operations 602 and 604.

The method 600 also includes, at an operation 606, the authentication component 122 or another component receiving a request to authenticate a user. For instance, at a later time, the same or a different user may use the same or a different computing device to enter input data. While doing so, the computing device may generate touch data using the metrics described above. The method 600 also includes, at an operation 608, receiving, from a computing device that includes a touchscreen display, input data inputted by a user via the touchscreen display. For instance, this operation may comprise receiving a PIN, password, username, or any other input data entered by the user. The method 600 also includes, at an operation 610, the authentication component 122 or another component receiving, from the computing device, second touch data representing one or more metrics associated with a physical interaction between the user and the touchscreen display as the user inputted the input data. These metrics may comprise any of the metrics described above or otherwise, such as a tap speed of the user, a touch area of an implement (e.g., finger) on the touchscreen, an angle of an implement (e.g., stylus, pen or finger), an amount of pressure on the touchscreen, or the like. The method 600 also includes, at an operation 612, the authentication component 122 or another component generating second signature data using the touch data representing the one or more metrics associated with the physical interaction between the user and the touchscreen display as the user input the input data.

FIG. 6B continues the illustration of the method 600 and includes, at an operation 614, the authentication component 122 or another component determining whether to authenticate the user. In some instances, this operation may comprise comparing the first signature data to the second signature data to determine a similarity score, and determining whether the similarity score is greater than a threshold similarity score. In another example, this operation may comprise the authentication component 122 or another component inputting the second signature data into a model that has been trained using the first signature data. If the authentication component 122 or another component determines at operation 614 that the user is to be authenticated, then an operation 616 represents the authentication component 122 or another component sending, to the computing device, an indication that the account of the user has been authenticated. If, however, the operation 614 determines that the user is not to be authenticated, then an operation 618 represents the authentication component 122 or another component sending, to the computing device, an indication that the account of the user has not been authenticated.

In addition, the method 600 may include, at an operation 620, determining that the input data comprises remote-access input provided to the computing device from a different computing device that is remote from the computing device. For instance, in response to determining that the first signature data does not match the second signature data, or in response to determining that the second signature data does not comply with an expected value of a metric entered on a touchscreen, then this operation may determine that the input data was entered remotely rather than locally on the device that allegedly sent the data and generated the touch data. For example, the second signature data can be obtained by obtaining “touch data” from historical data related to remote touch data or data collected from bots, simulated remote touch data, automated touch data, and the like, specifically to train the model on what qualifies as a remote touch data rather than human generated touch data.

Finally, the method 600 may include, at an operation 622, determining that the touch data has been not been generated based on a physical interaction between a touchscreen display of the computing device and a user of the computing device. Again, this determination may be made based on determining that the first signature data does not match the second signature data, or in response to determining that the second signature data does not comply with an expected value of a metric entered on a touchscreen, then this operation may determine that the input data was entered remotely (e.g., via bots or automated mouse clicks) rather than locally on the device that allegedly sent the data and generated the touch data and is not human generated touch data.

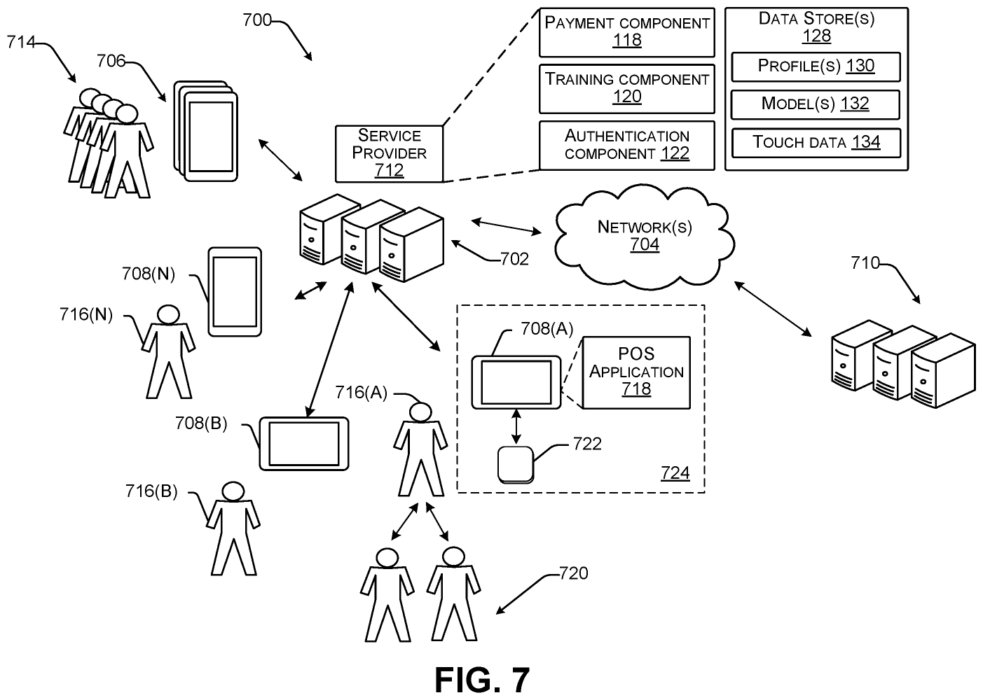

FIG. 7 illustrates an example environment 700. The environment 700 includes server(s) 702 that can communicate over a network 704 with user devices 706 (which, in some examples can be merchant devices 708 (individually, 708(A)-708(N))) and/or server(s) 710 associated with third-party service provider(s). The server(s) 702 can be associated with a service provider that can provide one or more services for the benefit of users 714, as described below. Actions attributed to the service provider can be performed by the server(s) 702.

The environment 700 can include a plurality of user devices 706, as described above. Each one of the plurality of user devices 706 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 714. The users 714 can be referred to as customers, buyers, merchants, sellers, borrowers, employees, employers, payors, payees, couriers and so on. The users 714 can interact with the user devices 706 via user interfaces presented via the user devices 706. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 706 can have an instance or versioned instance of an application, which can be downloaded from an application store, for example, which can present the user interface(s) described herein. In at least one example, a user 714 can interact with the user interface via touch input, spoken input, or any other type of input.

As described above, in at least one example, the users 714 can include merchants 716 (individually, 716(A)-716(N)). In an example, the merchants 716 can operate respective merchant devices 708, which can be user devices 706 configured for use by merchants 716. For the purpose of this discussion, a “merchant” can be any entity that offers items (e.g., goods or services) for purchase or other means of acquisition (e.g., rent, borrow, barter, etc.). The merchants 716 can offer items for purchase or other means of acquisition via brick-and-mortar stores, mobile stores (e.g., pop-up shops, food trucks, etc.), online stores, combinations of the foregoing, and so forth. In some examples, at least some of the merchants 716 can be associated with a same entity but can have different merchant locations and/or can have franchise/franchisee relationships. In additional or alternative examples, the merchants 716 can be different merchants. That is, in at least one example, the merchant 716(A) is a different merchant than the merchant 716(B) and/or the merchant 716(C).

For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

Each merchant device 708 can have an instance of a POS application 718 stored thereon. The POS application 718 can configure the merchant device 708 as a POS terminal, which enables the merchant 716(A) to interact with one or more customers 720. As described above, the users 714 can include customers, such as the customers 720 shown as interacting with the merchant 716(A). For the purpose of this discussion, a “customer” can be any entity that acquires items from merchants. While only two customers 720 are illustrated in FIG. 7, any number of customers 720 can interact with the merchants 716. Further, while FIG. 7 illustrates the customers 720 interacting with the merchant 716(A), the customers 720 can interact with any of the merchants 716.

In at least one example, interactions between the customers 720 and the merchants 716 that involve the exchange of funds (from the customers 720) for items (from the merchants 716) can be referred to as “transactions.” In at least one example, the POS application 718 can determine transaction data associated with the POS transactions. Transaction data can include payment information, which can be obtained from a reader device 722 associated with the merchant device 708(A), user authentication data, purchase amount information, point-of-purchase information (e.g., item(s) purchased, date of purchase, time of purchase, etc.), etc. The POS application 718 can send transaction data to the server(s) 702 such that the server(s) 702 can track transactions of the customers 720, merchants 716, and/or any of the users 714 over time. Furthermore, the POS application 718 can present a UI to enable the merchant 716(A) to interact with the POS application 718 and/or the service provider via the POS application 718.

In at least one example, the merchant device 708(A) can be a special-purpose computing device configured as a POS terminal (via the execution of the POS application 718). In at least one example, the POS terminal may be connected to a reader device 722, which is capable of accepting a variety of payment instruments, such as credit cards, debit cards, gift cards, short-range communication based payment instruments, and the like, as described below. In at least one example, the reader device 722 can plug in to a port in the merchant device 708(A), such as a microphone port, a headphone port, an audio-jack, a data port, or other suitable port. In additional or alternative examples, the reader device 722 can be coupled to the merchant device 708(A) via another wired or wireless connection, such as via a Bluetooth®, BLE, and so on. Additional details are described below with reference to FIG. 7. In some examples, the reader device 722 can read information from alternative payment instruments including, but not limited to, wristbands and the like.

In some examples, the reader device 722 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards or devices configured for tapping). The POS terminal may provide a rich user interface, communicate with the reader device 722, and communicate with the server(s) 702, which can provide, among other services, a payment processing service. The server(s) 702 associated with the service provider can communicate with server(s) 710, as described below. In this manner, the POS terminal and reader device 722 may collectively process transaction(s) between the merchants 716 and customers 720. In some examples, POS terminals and reader devices can be configured in one-to-one pairings. In other examples, the POS terminals and reader devices can be configured in many-to-one pairings (e.g., one POS terminal coupled to multiple reader devices or multiple POS terminals coupled to one reader device). In some examples, there could be multiple POS terminal(s) connected to a number of other devices, such as “secondary” terminals, e.g., back-of-the-house systems, printers, line-buster devices, POS readers, and the like, to allow for information from the secondary terminal to be shared between the primary POS terminal(s) and secondary terminal(s), for example via short-range communication technology. This kind of arrangement may also work in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 722 of the POS system 724 are shown as separate devices, in additional or alternative examples, the POS terminal and the reader device 722 can be part of a single device. In some examples, the reader device 722 can have a display integrated therein for presenting information to the customers 720. In additional or alternative examples, the POS terminal can have a display integrated therein for presenting information to the customers 720. POS systems, such as the POS system 724, may be mobile, such that POS terminals and reader devices may process transactions in disparate locations across the world. POS systems can be used for processing card-present transactions and card-not-present (CNP) transactions, as described below.

A card-present transaction is a transaction where both a customer 720 and his or her payment instrument are physically present at the time of the transaction. Card-present transactions may be processed by swipes, dips, taps, or any other interaction between a physical payment instrument (e.g., a card), or otherwise present payment instrument, and a reader device 722 whereby the reader device 722 is able to obtain payment data from the payment instrument. A swipe is a card-present transaction where a customer 720 slides a card, or other payment instrument, having a magnetic strip through a reader device 722 that captures payment data contained in the magnetic strip. A dip is a card-present transaction where a customer 720 inserts a payment instrument having an embedded microchip (i.e., chip) into a reader device 722 first. The dipped payment instrument remains in the payment reader until the reader device 722 prompts the customer 720 to remove the card, or other payment instrument. While the payment instrument is in the reader device 722, the microchip can create a one-time code which is sent from the POS system 724 to the server(s) 710 (which can be associated with third-party service providers that provide payment services, including but not limited to, an acquirer bank, an issuer, and/or a card payment network (e.g., Mastercard®, VISA®, etc.)) to be matched with an identical one-time code. A tap is a card-present transaction where a customer 720 may tap or hover his or her payment instrument (e.g., card, electronic device such as a smart phone running a payment application, etc.) over a reader device 722 to complete a transaction via short-range communication (e.g., NFC, RFID, Bluetooth®, BLE, etc.). Short-range communication enables the payment instrument to exchange information with the reader device 722. A tap may also be called a contactless payment.

A CNP transaction is a transaction where a card, or other payment instrument, is not physically present at the POS such that payment data is required to be manually keyed in (e.g., by a merchant, customer, etc.), or payment data is required to be recalled from a card-on-file data store, to complete the transaction.

The POS system 724, the server(s) 702, and/or the server(s) 710 may exchange payment information and transaction data to determine whether transactions are authorized. For example, the POS system 724 may provide encrypted payment data, user authentication data, purchase amount information, point-of-purchase information, etc. (collectively, transaction data) to server(s) 702 over the network(s) 704. The server(s) 702 may send the transaction data to the server(s) 710. As described above, in at least one example, the server(s) 710 can be associated with third-party service providers that provide payment services, including but not limited to, an acquirer bank, an issuer, and/or a card payment network (e.g., Mastercard®, VISA®, etc.)

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. The acquirer (e.g., the server(s) 710 associated therewith) can send a fund transfer request to a server computing device of a card payment network (e.g., Mastercard®, VISA®, etc.) to determine whether the transaction is authorized or deficient. In at least one example, the service provider can serve as an acquirer and connect directly with the card payment network.

The card payment network (e.g., the server(s) 710 associated therewith) can forward the fund transfer request to an issuing bank (e.g., “issuer”). The issuer is a bank or financial institution that offers a financial account (e.g., credit or debit card account) to a user. An issuer can issue payment cards to users and can pay acquirers for purchases made by cardholders to which the issuing bank has issued a payment card. The issuer (e.g., the server(s) 710 associated therewith) can make a determination as to whether the customer has the capacity to absorb the relevant charge associated with the payment transaction. In at least one example, the service provider can serve as an issuer and/or can partner with an issuer. The transaction is either approved or rejected by the issuer and/or the card payment network (e.g., the server(s) 710 associated therewith), and a payment authorization message is communicated from the issuer to the POS device via a path opposite of that described above, or via an alternate path.

As described above, the server(s) 710, which can be associated with payment service provider(s), may determine whether the transaction is authorized based on the transaction data, as well as information relating to parties to the transaction (e.g., the customer 720 and/or the merchant 716(A)). The server(s) 710 may send an authorization notification over the network(s) 704 to the server(s) 702, which may send the authorization notification to the POS system 724 over the network(s) 704 to indicate whether the transaction is authorized. The server(s) 702 may also transmit additional information such as transaction identifiers to the POS system 724. In one example, the server(s) 702 may include a merchant application and/or other functional components for communicating with the POS system 724 and/or the server(s) 710 to authorize or decline transactions.

Based on the authentication notification that is received by the POS system 724 from server(s) 702, the merchant 716(A) may indicate to the customer 720 whether the transaction has been approved. In some examples, approval may be indicated at the POS system 724, for example, at a display of the POS system 724. In other examples, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

As mentioned above, the service provider can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, and so on. In some examples, the users 714 can access all of the services of the service provider. In other examples, the users 714 can have gradated access to the services, which can be based on risk tolerance, IDV outputs, subscriptions, and so on. In at least one example, access to such services can be availed to the merchants 716 via the POS application 718. In additional or alternative examples, each service can be associated with its own access point (e.g., application, web browser, etc.).

The service provider can offer payment processing services for processing payments on behalf of the merchants 716, as described above. For example, the service provider can provision payment processing software, payment processing hardware and/or payment processing services to merchants 716, as described above, to enable the merchants 716 to receive payments from the customers 720 when conducting POS transactions with the customers 720. For instance, the service provider can enable the merchants 716 to receive cash payments, payment card payments, and/or electronic payments from customers 720 for POS transactions and the service provider can process transactions on behalf of the merchants 716.

As the service provider processes transactions on behalf of the merchants 716, the service provider can maintain accounts or balances for the merchants 716 in one or more ledgers. For example, the service provider can analyze transaction data received for a transaction to determine an amount of funds owed to a merchant 716(A) for the transaction. In at least one example, such an amount can be a total purchase price less fees charged by the service provider for providing the payment processing services. Based on determining the amount of funds owed to the merchant 716(A), the service provider can deposit funds into an account of the merchant 716(A). The account can have a stored balance, which can be managed by the service provider. The account can be different from a conventional bank account at least because the stored balance is managed by a ledger of the service provider and the associated funds are accessible via various withdrawal channels including, but not limited to, scheduled deposit, same-day deposit, instant deposit, and a linked payment instrument.

A scheduled deposit can occur when the service provider transfers funds associated with a stored balance of the merchant 716(A) to a bank account of the merchant 716(A) that is held at a bank or other financial institution (e.g., associated with the server(s) 710). Scheduled deposits can occur at a prearranged time after a POS transaction is funded, which can be a business day after the POS transaction occurred, or sooner or later. In some examples, the merchant 716(A) can access funds prior to a scheduled deposit. For instance, the merchant 716(A) may have access to same-day deposits (e.g., wherein the service provider deposits funds from the stored balance to a linked bank account of the merchant on a same day as POS transaction, in some examples prior to the POS transaction being funded) or instant deposits (e.g., wherein the service provider deposits funds from the stored balance to a linked bank account of the merchant on demand, such as responsive to a request). Further, in at least one example, the merchant 716(A) can have a payment instrument that is linked to the stored balance that enables the merchant to access the funds without first transferring the funds from the account managed by the service provider to the bank account of the merchant 716(A).

In at least one example, the service provider may provide inventory management services. That is, the service provider may provide inventory tracking and reporting. Inventory management services may enable the merchant 716(A) to access and manage a database storing data associated with a quantity of each item that the merchant 716(A) has available (i.e., an inventory). Furthermore, in at least one example, the service provider can provide catalog management services to enable the merchant 716(A) to maintain a catalog, which can be a database storing data associated with items that the merchant 716(A) has available for acquisition (i.e., catalog management services). In at least one example, the catalog may include a plurality of data items and a data item of the plurality of data items may represent an item that the merchant 716(A) has available for acquisition. The service provider can offer recommendations related to pricing of the items, placement of items on the catalog, and multi-party fulfilment of the inventory.

In at least one example, the service provider can provide business banking services, which allow the merchant 716(A) to track deposits (from payment processing and/or other sources of funds) into an account of the merchant 716(A), payroll payments from the account (e.g., payments to employees of the merchant 716(A)), payments to other merchants (e.g., business-to-business) directly from the account or from a linked debit card, withdrawals made via scheduled deposit and/or instant deposit, etc. Furthermore, the business banking services can enable the merchant 716(A) to obtain a customized payment instrument (e.g., credit card), check how much money they are earning (e.g., via presentation of available earned balance), understand where their money is going (e.g., via deposit reports (which can include a breakdown of fees), spend reports, etc.), access/use earned money (e.g., via scheduled deposit, instant deposit, linked payment instrument, etc.), feel in control of their money (e.g., via management of deposit schedule, deposit speed, linked instruments, etc.), etc. Moreover, the business banking services can enable the merchants 716 to visualize their cash flow to track their financial health, set aside money for upcoming obligations (e.g., savings), organize money around goals, etc.

In at least one example, the service provider can provide financing services and products, such as via business loans, consumer loans, fixed term loans, flexible term loans, and the like. In at least one example, the service provider can utilize one or more risk signals to determine whether to extend financing offers and/or terms associated with such financing offers.

In at least one example, the service provider can provide financing services for offering and/or lending a loan to a borrower that is to be used for, in some instances, financing the borrower's short-term operational needs (e.g., a capital loan). For instance, a potential borrower that is a merchant can obtain a capital loan via a capital loan product in order to finance various operational costs (e.g., rent, payroll, inventory, etc.). In at least one example, the service provider can offer different types of capital loan products. For instance, in at least one example, the service provider can offer a daily repayment loan product, wherein a capital loan is repaid daily, for instance, from a portion of transactions processed by the payment processing service on behalf of the borrower. Additionally and/or alternatively, the service provider can offer a monthly repayment loan product, wherein a capital loan is repaid monthly, for instance, via a debit from a bank account linked to the payment processing service. The credit risk of the merchant may be evaluated using risk models that take into account factors, such as payment volume, credit risk of similarly situated merchants, past transaction history, seasonality, credit history, and so on.

Additionally or alternatively, the service provider can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant, which can be one of the merchants 716. The service provider can generate the loan based at least in part on determining that the borrower purchased or intends to purchase the item from the merchant. The loan can be associated with a balance based on an actual purchase price of the item and the borrower can repay the loan over time. In some examples, the borrower can repay the loan via installments, which can be paid via funds managed and/or maintained by the service provider (e.g., from payments owed to the merchant from payments processed on behalf of the merchant, funds transferred to the merchant, etc.). The service provider can offer specific financial products, such as payment instruments, tied specifically to the loan products. For example, in one implementation, the server provider 712 associates capital to a merchant or customer's debit card, where the use of the debit card is defined by the terms of the loan. In some examples, the merchant may only use the debit card for making specific purchases. In other examples, the “installment” associated with the loan product is credited directly via the payment instrument. The payment instrument is thus customized to the loan and/or the parties associated with the loan.

As illustrated, the service provider 712 of FIG. 7 may include the components described above with reference to FIG. 1. For instance, the service provider 712 may include the payment component 118, the training component 120, and the authentication component 120. In addition, the service provider 712 can include the data store(s) storing the profile data 130, the machine-learned models 132, and the touch data 134 received from varying user devices. In the example of FIG. 7, the payment component 118 may function to process payment requests from customers 720 and via a POS application 718. As part of this payment processing, respective devices of the customers 720 (or the merchant) may provide, to the service provider 712, input data as well as touch data generated by a touch sensor of the respective device while the user entered the input data. Upon receiving this information, the authentication component 122 may analyze both the input data and the touch data using the techniques described above in order to determine whether to proceed with processing payment for the requested transaction.

For instance, a customer illustrated in FIG. 7 may request to acquire an item from a merchant, with the user or merchant operating the POS application 718 to pay for the item. As part of this checkout flow, the customer or the merchant may enter information to identify or authenticate the customer or merchant, such as a PIN, password, or the like associated with the customer or merchant. While the customer or merchant enters this information, the device 708(A) may generate the touch data and send this touch data to the service provider along with the input data provided by the customer or merchant. The authentication component 122 may then use the input data and the touch data to determine whether to process payment for the transaction. For instance, the authentication component 122 may analyze the touch data using the techniques described above, such as inputting the touch data into a model that has been trained for the customer or merchant and may output an indication regarding whether the touch data corresponds to the merchant or customer and, thus, whether or not the transaction should proceed.

The service provider can provide web-development services, which enable users 714 who are unfamiliar with HTML, XML, Javascript, CSS, or other web design tools to create and maintain professional and aesthetically pleasing websites. Some of these web page editing applications allow users to build a web page and/or modify a web page (e.g., change, add, or remove content associated with a web page). Further, in addition to websites, the web-development services can create and maintain other online omni-channel presences, such as social media posts for example. In some examples, the resulting web page(s) and/or other content items can be used for offering item(s) for sale via an online/e-commerce platform. That is, the resulting web page(s) and/or other content items can be associated with an online store or offering by the one or more of the merchants 716. In at least one example, the service provider can recommend and/or generate content items to supplement omni-channel presences of the merchants 716. That is, if a merchant of the merchants 716 has a web page, the service provider—via the web-development or other services—can recommend and/or generate additional content items to be presented via other channel(s), such as social media, email, etc.

Furthermore, the service provider can provide payroll services to enable employers to pay employees for work performed on behalf of employers. In at least one example, the service provider can receive data that includes time worked by an employee (e.g., through imported timecards and/or POS interactions), sales made by the employee, gratuities received by the employee, and so forth. Based on such data, the service provider can make payroll payments to employee(s) on behalf of an employer via the payroll service. For instance, the service provider can facilitate the transfer of a total amount to be paid out for the payroll of an employee from the bank of the employer to the bank of the service provider to be used to make payroll payments. In at least one example, when the funds have been received at the bank of the service provider, the service provider can pay the employee, such as by check or direct deposit, often a day, a week, or more after when the work was actually performed by the employee. In additional or alternative examples, the service provider can enable employee(s) to receive payments via same-day or instant deposit based at least in part on risk and/or reliability analyses performed by the service provider.

Moreover, in at least one example, the service provider can provide employee management services for managing schedules of employees. Further, the service provider can provide appointment services for enabling users 714 to set schedules for scheduling appointments and/or users 714 to schedule appointments.

In some examples, the service provider can provide restaurant management services to enable users 714 to make and/or manage reservations, to monitor front-of-house and/or back-of-house operations, and so on. In such examples, the merchant device(s) 708 and/or server(s) 702 can be configured to communicate with one or more other computing devices, which can be located in the front-of-house (e.g., POS device(s)) and/or back-of-house (e.g., kitchen display system(s) (KDS)). In at least one example, the service provider can provide order management services and/or fulfillment services to enable restaurants to manage open tickets, split tickets, and so on and/or manage fulfillment services. In some examples, such services can be associated with restaurant merchants, as described above. In additional or alternative examples, such services can be any type of merchant.

In at least one example, the service provider can provide fulfilment services, which can use couriers for delivery, wherein couriers can travel between multiple locations to provide delivery services, photography services, etc. Couriers can be users 714 who can travel between locations to perform services for a requesting user 714 (e.g., deliver items, capture images, etc.). In some examples, the courier can receive compensation from the service provider. The courier can employ one or more vehicles, such as automobiles, bicycles, scooters, motorcycles, buses, airplanes, helicopters, boats, skateboards, etc. Although, in other instances the courier can travel by foot or otherwise without a vehicle. Some examples discussed herein enable people to participate as couriers in a type of crowdsourced service economy. Here, essentially any person with a mobile device is able to immediately become a courier, or cease to be a courier, in a courier network that provides services as described herein. In at least one example, the couriers can be unmanned aerial vehicles (e.g., drones), autonomous vehicles, or any other type of vehicle capable of receiving instructions for traveling between locations. In some examples, the service provider can receive requests for courier services, automatically assign the requests to active couriers, and communicate dispatch instructions to couriers via user interface (e.g., application, web browser, or other access point) presented via respective devices 706.

In some examples, the service provider can provide omni-channel fulfillment services. For instance, if a customer places an order with a merchant and the merchant cannot fulfill the order because one or more items are out of stock or otherwise unavailable, the service provider can leverage other merchants and/or sales channels that are part of the platform of the service provider to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the service provider can enable conversational commerce via conversational commerce services, which can use one or more machine learning mechanisms to analyze messages exchanged between two or more users 714, voice inputs into a virtual assistant or the like, to determine intents of user(s) 714. In some examples, the service provider can utilize determined intents to automate customer service, offer promotions, provide recommendations, or otherwise interact with customers in real-time. In at least one example, the service provider can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 714 may be new to the service provider such that the user 714 that has not registered (e.g., subscribed to receive access to one or more services offered by the service provider) with the service provider. The service provider can offer onboarding services for registering a potential user 714 with the service provider. In some examples, onboarding can involve presenting various questions, prompts, and the like to a potential user 714 to obtain information that can be used to generate a profile for the potential user 714. In at least one example, the service provider can provide limited or short-term access to its services prior to, or during, onboarding (e.g., a user of a peer-to-peer payment service can transfer and/or receive funds prior to being fully onboarded, a merchant can process payments prior to being fully onboarded, etc.). In at least one example, responsive to the potential user 714 providing all necessary information, the potential user 714 can be onboarded to the service provider. In such an example, any limited or short-term access to services of the service provider can be transitioned to more permissive (e.g., less limited) or longer-term access to such services.

The service provider can be associated with IDV services, which can be used by the service provider for compliance purposes and/or can be offered as a service, for instance to third-party service providers (e.g., associated with the server(s) 710). That is, the service provider can offer IDV services to verify the identity of users 714 seeking to use or using their services. Identity verification requires a customer (or potential customer) to provide information that is used by compliance departments to prove that the information is associated with an identity of a real person or entity. In at least one example, the service provider can perform services for determining whether identifying information provided by a user 714 accurately identifies the customer (or potential customer) (i.e., Is the customer who they say they are?).

The service provider is capable of providing additional or alternative services and the services described above are offered as a sampling of services. In at least one example, the service provider can exchange data with the server(s) 710 associated with third-party service providers. Such third-party service providers can provide information that enables the service provider to provide services, such as those described above. In additional or alternative examples, such third-party service providers can access services of the service provider. That is, in some examples, the third-party service providers can be subscribers, or otherwise access, services of the service provider.

Techniques described herein can be configured to operate in both real-time/online and offline modes. “Online” modes refer to modes when devices are capable of communicating with the service provider (e.g., the server(s) 702) and/or the server(s) 710 via the network(s) 704. In some examples, the merchant device(s) 708 are not capable of connecting with the service provider (e.g., the server(s) 702) and/or the server(s) 710, due to a network connectivity issue, for example. In additional or alternative examples, the server(s) 702 are not capable of communicating with the server(s) 710 due to network connectivity issue, for example. In such examples, devices may operate in “offline” mode where at least some payment data is stored (e.g., on the merchant device(s) 708) and/or the server(s) 702 until connectivity is restored and the payment data can be transmitted to the server(s) 702 and/or the server(s) 710 for processing.

In at least one example, the service provider can be associated with a hub, such as an order hub, an inventory hub, a fulfillment hub and so on, which can enable integration with one or more additional service providers (e.g., associated with the additional server(s) 710). In some examples, such additional service providers can offer additional or alternative services and the service provider can provide an interface or other computer-readable instructions to integrate functionality of the service provider into the one or more additional service providers.

Techniques described herein are directed to services provided via a distributed system of user devices 706 that are in communication with one or more server computing devices 702 of the service provider. That is, techniques described herein are directed to a specific implementation—or, a practical application—of utilizing a distributed system of user devices 706 that are in communication with one or more server computing devices 702 of the service provider to perform a variety of services, as described above. The unconventional configuration of the distributed system described herein enables the server(s) 702 that are remotely-located from end-users (e.g., users 714) to intelligently offer services based on aggregated data associated with the end-users, such as the users 714 (e.g., data associated with multiple, different merchants and/or multiple, different buyers), in some examples, in near-real time. Accordingly, techniques described herein are directed to a particular arrangement of elements that offer technical improvements over conventional techniques for performing payment processing services and the like. For small business owners in particular, the business environment is typically fragmented and relies on unrelated tools and programs, making it difficult for an owner to manually consolidate and view such data. The techniques described herein constantly or periodically monitor disparate and distinct merchant accounts, e.g., accounts within the control of the service provider, and those outside of the control of the service provider, to track the business standing (payables, receivables, payroll, invoices, appointments, capital, etc.) of the merchants. The techniques herein provide a consolidated view of a merchant's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services and/or additional or alternative services described herein. In some implementations, the distributed system is capable of applying the intelligence derived from an existing user base to a new user, thereby making the onboarding experience for the new user personalized and frictionless when compared to traditional onboarding methods. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 714 and user devices 706. Furthermore, such features are changed dynamically based on the profiles of the users involved interacting with the GUIs. As such, techniques described herein are directed to improvements to computing systems.

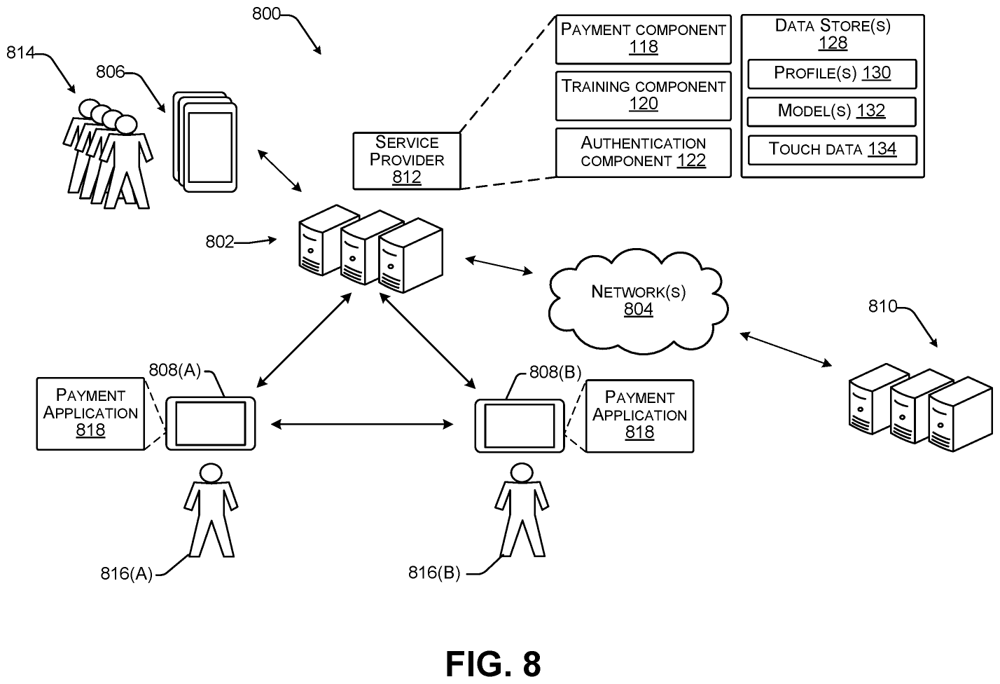

FIG. 8 illustrates an example environment 800. The environment 800 includes server(s) 802 that can communicate over a network 804 with user devices 806 (which, in some examples can be user devices 808 (individually, 808(A), 808(B)) and/or server(s) 810 associated with third-party service provider(s). The server(s) 802 can be associated with a service provider 812 that can provide one or more services for the benefit of users 814, as described below. Actions attributed to the service provider 812 can be performed by the server(s) 802. In some examples, the service provider 712 referenced in FIG. 7 can be the same or different than the service provider 812 referenced in FIG. 8.

The environment 800 can include a plurality of user devices 806, as described above. Each one of the plurality of user devices 806 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 814. The users 814 can be referred to as customers, buyers, merchants, sellers, borrowers, employees, employers, payors, payees, couriers and so on. The users 814 can interact with the user devices 806 via user interfaces presented via the user devices 806. In at least one example, a user interface can be presented via a web browser, or the like. In other examples, a user interface can be presented via an application, such as a mobile application or desktop application, which can be provided by the service provider 812 or which can be an otherwise dedicated application. In some examples, individual of the user devices 806 can have an instance or versioned instance of an application, which can be downloaded from an application store, for example, which can present the user interface(s) described herein. In at least one example, a user 814 can interact with the user interface via touch input, spoken input, or any other type of input.

In at least one example, the service provider 812 can provide a peer-to-peer payment service that enables peer-to-peer payments between two or more users 814. Two users, user 816(A) and user 816(B) are illustrated in FIG. 8 as “peers” in a peer-to-peer payment. In at least one example, the service provider 812 can communicate with instances of a payment application 818 (or other access point) installed on devices 806 configured for operation by users 814. In an example, an instance of the payment application 818 executing on a first device 808(A) operated by a payor (e.g., user 816(A)) can send a request to the service provider 812 to transfer an asset (e.g., fiat currency, non-fiat currency, cryptocurrency, securities, gift cards, and/or related assets) from the payor to a payee (e.g., user 816(B)) via a peer-to-peer payment. In some examples, assets associated with an account of the payor are transferred to an account of the payee. In some examples, assets can be held at least temporarily in an account of the service provider 812 prior to transferring the assets to the account of the payee.

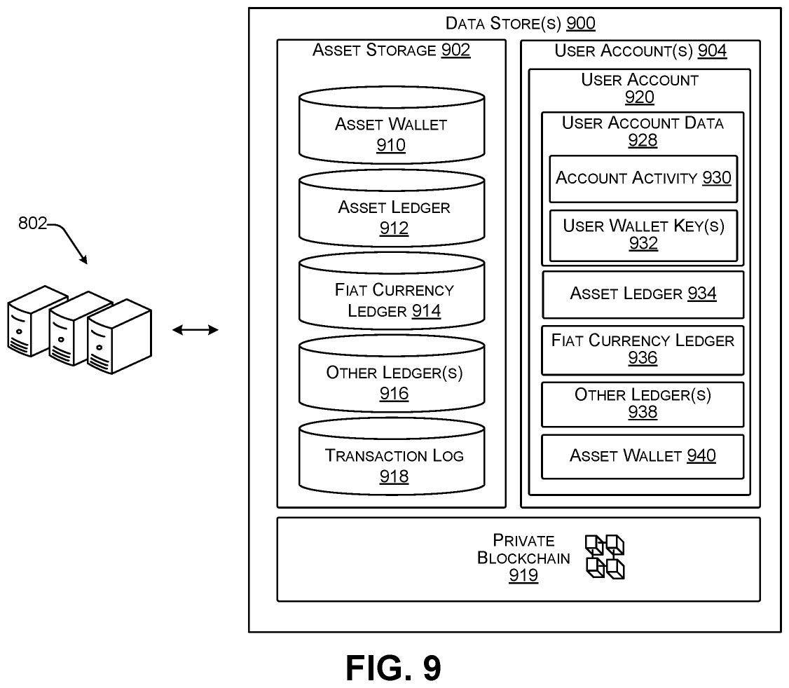

In some examples, the service provider 812 can utilize a ledger system to track transfers of assets between users 806. FIG. 9, below, provides additional details associated with such a ledger system. The ledger system can enable users 806 to own fractional shares of assets that are not conventionally available. For instance, a user can own a fraction of a Bitcoin or a stock. Additional details are described herein.

In at least one example, the service provider 812 can facilitate transfers and can send notifications related thereto to instances of the payment application 818 executing on user device(s) of payee(s). As an example, the service provider 812 can transfer assets from an account of user 816(A) to an account of the user 816(B) and can send a notification to the user device 808(B) of the user 816(B) for presentation via a user interface. The notification can indicate that a transfer is in process, a transfer is complete, or the like. In some examples, the service provider 812 can send additional or alternative information to the instances of the payment application 818 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the service provider 812 funds the request to payee on behalf of the payor, to speed up the transfer process and compensate for any lags that may be attributed to the payor's financial network.

In some examples, the service provider can trigger the peer-to-peer payment process through identification of a “payment proxy” having a particular syntax. For example, the syntax can include a monetary currency indicator prefixing one or more alphanumeric characters (e.g., $Cash). The currency indicator operates as the tagging mechanism that indicates to the server(s) 802 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol could equally be used. In some examples, additional or alternative identifiers can be used to trigger the peer-to-peer payment process. For instance, email, telephone number, social media handles, and/or the like can be used to trigger and/or identify users of a peer-to-peer payment process.

In some examples, the peer-to-peer payment process can be initiated through instances of the payment application 818 executing on the user devices 806. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can include a payment proxy discussed above. The service provider 812 can generate the landing page to enable the recipient to conveniently receive one or more payments from one or more senders. In some examples, the personalized location address identifying the landing page can be a uniform resource locator (URL) that incorporates the payment proxy. In such examples, the landing page can be a web page, e.g., www.cash.me/$Cash.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. In some examples, the content provider can be the service provider 812 as described with reference to FIG. 8 or a third-party service provider associated with the server(s) 810. In examples where the content provider is a third-party service provider, the server(s) 810 can be accessible via one or more APIs or other integrations. The forum can be employed by a content provider to enable users of the forum to interact with one another (e.g., through creating messages, posting comments, etc.). In some examples, “forum” may also refer to an application or webpage of an e-commerce or retail organization that offers products and/or services. Such websites can provide an online “form” to complete before or after the products or services are added to a virtual cart. The online form may include one or more fields to receive user interaction and engagement. Examples include name and other identification of the user, shipping address of the user, etc. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be employed by the service provider 812 referenced in FIG. 8. For instance, the service provider 812 can offer messaging services that provides a communication service to users via a messaging application (e.g., chat or messaging capability).

The messaging application can include, for example, a text messaging application for communication between phones (e.g., conventional mobile telephones or smartphones), or a cross-platform instant messaging application for smartphones and phones that use the Internet for communication. The messaging application can be executed on a user device 806 (e.g., mobile device or conventional personal computer (PC)) based on instructions transmitted to and from the server(s) 802 (which, in such an example can be called a “messaging server”). In some instances, the messaging application can include a payment application with messaging capability that enables users of the payment application to communicate with one another. In such instances, the payment application can be executed on a user device 806 based on instructions transmitted to and from the server(s) 802 (e.g., the payment service discussed in this description or another payment service that supports payment transactions). In some examples, the messaging application can be provided by a third-party service provider associated with the server(s) 810. In examples where the messaging application is a third-party service provider, the server(s) 810 can be accessible via one or more APIs or other integrations.

As described above, the service provider can facilitate peer-to-peer transactions, which can enable users 806 to transfer fiat currency, non-fiat currency, cryptocurrency, securities, or other assets, or portions thereof, to other users 806. In at least one example, individual users can be associated with user accounts. Additional details associated with user accounts and the transfer of assets between users 806 are described below with reference to FIG. 9.

Furthermore, the service provider 812 of FIG. 8 can enable users 806 to perform banking transactions via instances of the payment application 818. For example, users can configure direct deposits or other deposits for adding assets to their various ledgers/balances. Further, users 806 can configure bill pay, recurring payments, and/or the like using assets associated with their accounts. In addition to sending and/or receiving assets via peer-to-peer transactions, users 806 buy and/or sell assets via asset networks such as cryptocurrency networks, securities networks, and/or the like.

In addition to the above, the service provider 812 may perform some or all of the authentication techniques described above with reference to FIGS. 1-7. For instance, and as illustrated, the service provider 812 may include the components described above with reference to FIG. 1. For instance, the service provider 812 may include the payment component 118, the training component 120, and the authentication component 120, as well as the data store(s) 128 storing the profile data 130, the machine-learned models 132, and the touch data 134 received from varying user devices. In the example of FIG. 8, the payment component 118 may function to P2P payment transactions between users, such as a P2P payment transaction between the user 816(A) and the user 816(B). As part of this P2P transaction, one or both of the users may provide input data and touch data to the service provider 812. Upon receiving this information, the authentication component 122 may analyze both the input data and the touch data using the techniques described above in order to determine whether to proceed with the requested P2P payment transaction.

For instance, the user 816(A) may request to provide a P2P payment to the user 816(B) using the payment application 818. As part of this transaction flow, the user 816(A) may enter information to identify or authenticate themselves, such as a PIN, password, or the like associated with the user 816(A). While the user 816(A) enters this information, the device 808(A) may generate the touch data and send this touch data to the service provider 812 along with the input data provided by the user 816(A). The authentication component 122 may then use the input data and the touch data to determine whether to proceed with the P2P transaction. For instance, the authentication component 122 may analyze the touch data using the techniques described above, such as inputting the touch data into a model that has been trained for the user 816(A) and may output an indication regarding whether the touch data corresponds to the user 816(A) and, thus, whether or not the transaction should proceed.

In addition, upon the payment application 818 operating on the device 808(B) of the user 816(B) displaying a notification that the user 816(B) has received a P2P payment, the payment application may request that the user 816(B) enter a PIN, password, or the like to accept the payment. Again, the device 808(B) may generate touch data while the user 816(B) enters the input data, and the device 808(B) may send this input data and the touch data to the service provider 812. Upon receiving the data, the authentication component 122 may use the input data and the touch data to determine whether to finalize the P2P payment. For instance, the authentication component 122 may input the touch data into a machine-learned model associated with the user 816(B) to determine whether the user 816(B) entered the input data and, thus, whether to finalize the P2P payment.

Furthermore, and as discussed below with reference to FIG. 9, payments to merchants and/or P2P payments may be made using any sort of asset, including hard currency, cryptocurrency, or the like. In this regard, it is to be appreciated that the techniques for using touch data to authenticate or deny a transaction may be performed in instances where cryptocurrency is involved, such as when attempting to authenticate a blockchain transaction in an architecture similar or the same as that discussed below with reference to FIG. 9.

FIG. 9 illustrates example data store(s) 900 that can be associated with the server(s) 802. In at least one example, the data store(s) 900 can store assets in an asset storage 902, as well as data in user account(s) 904, merchant account(s) 906, and/or customer account(s) 908. In at least one example, the asset storage 902 can be used to store assets managed by the service provider 812 of FIG. 8. In at least one example, the asset storage 902 can be used to record whether individual of the assets are registered to users. For example, the asset storage 902 can include an asset wallet 910 for storing records of assets owned by the service provider of FIG. 8, such as cryptocurrency, securities, or the like, and communicating with one or more asset networks, such as cryptocurrency networks, securities networks, or the like. In some examples, the asset network can be a first-party network or a third-party network, such as a cryptocurrency exchange or the stock market. In examples where the asset network is a third-party network, the server(s) 810 can be associated therewith. In some examples, the asset wallet 910 can communication with the asset network via one or more components associated with the server(s) 802.

The asset wallet 910 can be associated with one or more addresses and can vary addresses used to acquire assets (e.g., from the asset network(s)) so that its holdings are represented under a variety of addresses on the asset network. In examples where the service provider of FIG. 8 has its own holdings of cryptocurrency (e.g., in the asset wallet 910), a user can acquire cryptocurrency directly from the service provider of FIG. 8. In some examples, the service provider of FIG. 8 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In all of these scenarios, the buying and selling of cryptocurrency, and therefore the associated updating of the public ledger of asset network can be separate from any customer-merchant transaction or peer-to-peer transaction, and therefore not necessarily time-sensitive. This can enable batching transactions to reduce computational resources and/or costs. The service provider can provide the same or similar functionality for securities or other assets.

The asset storage 902 may contain ledgers that store records of assignments of assets to users 806. Specifically, the asset storage 902 may include asset ledger 910, fiat currency ledger 914, and other ledger(s) 916, which can be used to record transfers of assets between users 806 of the service provider and/or one or more third-parties (e.g., merchant network(s), payment card network(s), ACH network(s), equities network(s), the asset network, securities networks, etc.). In doing so, the asset storage 902 can maintain a running balance of assets managed by the service provider of FIG. 8. The ledger(s) of the asset storage 902 can further indicate some of the running balance for each of the ledger(s) stored in the asset storage 902 is assigned or registered to one or more user account(s) 904.

In at least one example, the asset storage 902 can include transaction logs 918, which can include records of past transactions involving the service provider of FIG. 8. In at least one example, transaction data, as described herein, can be stored in association with the transaction logs 918.

In some examples, the data store(s) 900 can store a private blockchain 919. A private blockchain 919 can function to record sender addresses, recipient addresses, public keys, values of cryptocurrency transferred, and/or can be used to verify ownership of cryptocurrency tokens to be transferred. In some examples, the service provider of FIG. 8 can record transactions taking place within the service provider of FIG. 8 involving cryptocurrency until the number of transactions has exceeded a determined limit (e.g., number of transactions, storage space allocation, etc.). Based at least in part on determining that the limit has been reached, the service provider of FIG. 8 can publish the transactions in the private blockchain 919 to a public blockchain (e.g., associated with the asset network), where miners can verify the transactions and record the transactions to blocks on the public blockchain. In at least one example, the service provider of FIG. 8 can participate as miner(s) at least for its transactions to be posted to the public blockchain.

In at least one example, the data store(s) 900 can store and/or manage accounts, such as user account(s) 904, merchant account(s) 906, and/or customer account(s) 908. In at least one example, the user account(s) 904 may store records of user accounts associated with the users 806. In at least one example, the user account(s) 904 can include a user account 920, which can be associated with a user (of the users 806). Other user accounts of the user account(s) 904 can be similarly structured to the user account 920, according to some examples. In other examples, other user accounts may include more or less data and/or account information than that provided by the user account 920. In at least one example, the user account 920 can include user account data 928, which can include, but is not limited to, data associated with user identifying information (e.g., name, phone number, address, etc.), user identifier(s) (e.g., alphanumeric identifiers, etc.), user preferences (e.g., learned or user-specified), purchase history data (e.g., identifying one or more items purchased (and respective item information), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 928 can include account activity 930 and user wallet key(s) 932. The account activity 930 may include a transaction log for recording transactions associated with the user account 920. In some examples, the user wallet key(s) 932 can include a public-private key-pair and a respective address associated with the asset network or other asset networks. In some examples, the user wallet key(s) 932 may include one or more key pairs, which can be unique to the asset network or other asset networks.

In addition to the user account data 928, the user account 920 can include ledger(s) for account(s) managed by the service provider of FIG. 8, for the user. For example, the user account 920 may include an asset ledger 934, a fiat currency ledger 936, and/or one or more other ledgers 938. The ledger(s) can indicate that a corresponding user utilizes the service provider of FIG. 8 to manage corresponding accounts (e.g., a cryptocurrency account, a securities account, a fiat currency account, etc.). It should be noted that in some examples, the ledger(s) can be logical ledger(s) and the data can be represented in a single database. In some examples, individual of the ledger(s), or portions thereof, can be maintained by the service provider of FIG. 8.

In some examples, the asset ledger 934 can store a balance for each of one or more cryptocurrencies (e.g., Bitcoin, Ethereum, Litecoin, etc.) registered to the user account 920. In at least one example, the asset ledger 934 can further record transactions of cryptocurrency assets associated with the user account 920. For example, the user account 920 can receive cryptocurrency from the asset network using the user wallet key(s) 932. In some examples, the user wallet key(s) 932 may be generated for the user upon request. User wallet key(s) 932 can be requested by the user in order to send, exchange, or otherwise control the balance of cryptocurrency held by the service provider of FIG. 8 (e.g., in the asset wallet 910) and registered to the user. In some examples, the user wallet key(s) 932 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider of FIG. 8 and the value is credited as a balance in asset ledger 934), by purchasing currency in the form associated with the account using currency in a different form (e.g., buying a value of cryptocurrency from the service provider of FIG. 8 using a value of fiat currency reflected in fiat currency ledger 206, and crediting the value of cryptocurrency in asset ledger 934), or by conducting a transaction with another user (customer or merchant) of the service provider of FIG. 8 wherein the account receives incoming currency (which can be in the form associated with the account or a different form, in which the incoming currency may be converted to the form associated with the account). In some examples, the user account data 928 can include preferences for maintaining balances of individual of the ledgers. For example, the service provider of FIG. 8 can automatically debit the fiat currency ledger 936 to increase the asset ledger 934, or another account associated with the user whenever the cryptocurrency balance (e.g., of the asset ledger 934) falls below a stated level (e.g., a threshold). Conversely, in some embodiments, the service provider of FIG. 8 can automatically credit the fiat currency ledger 936 to decrease the asset ledger 934 whenever cryptocurrency balance rises above a stated level (e.g., a threshold). In some examples, automatic transactions can be further defined by an exchange rate between the cryptocurrency and the fiat currency such that transactions to buy or sell cryptocurrency can occur when exchange rates are favorable.

With specific reference to funding a cryptocurrency account, a user may have a balance of cryptocurrency stored in another cryptocurrency wallet. In some examples, the other cryptocurrency wallet can be associated with a third-party (e.g., associated with the third-party server(s) 120) unrelated to the service provider of FIG. 8 (i.e., an external account). In at least one example, the user can transfer all or a portion of a balance of the cryptocurrency stored in the third-party cryptocurrency wallet to the service provider of FIG. 8. Such a transaction can require the user to transfer an amount of the cryptocurrency in a message signed by user's private key to an address provided by the service provider of FIG. 8. In at least one example, the transaction can be sent to miners to bundle the transaction into a block of transactions and to verify the authenticity of the transactions in the block. Once a miner has verified the block, the block is written to a public, distributed blockchain where the service provider of FIG. 8 can then verify that the transaction has been confirmed and can credit the user's asset ledger 934 with the transferred amount. When an account is funded by transferring cryptocurrency from a third-party cryptocurrency wallet, an update can be made to the public blockchain. Importantly, this update of the public blockchain need not take place at a time critical moment, such as when a transaction is being processed by a merchant in store or online.

In some examples, a user can purchase cryptocurrency to fund their cryptocurrency account. In some examples, the user can purchase cryptocurrency through services offered by the service provider of FIG. 8. As described above, in some examples, the service provider of FIG. 8 can acquire cryptocurrency from a third-party source (e.g., associated with the third-party server(s) 118). In such examples, the asset wallet 910 can be associated with different addresses and can vary addresses used to acquire cryptocurrency so that its holdings are represented under a variety of addresses on a blockchain. When the service provider of FIG. 8 has their own holdings of cryptocurrency, users can acquire cryptocurrency directly from the service provider of FIG. 8. In some examples, the service provider of FIG. 8 can include logic for buying and selling cryptocurrency in order to maintain a desired level of cryptocurrency. The desired level can be based on a volume of transactions over a period, balances of collective user profiles cryptocurrency ledgers, exchange rates, or trends in changing of exchange rates such that the cryptocurrency is trending towards gaining or losing value with respect to the fiat currency. In all of these examples, the buying and selling of cryptocurrency, and therefore the associated updating of the public ledger can be separate from any customer-merchant transaction, and therefore not necessarily time-sensitive.

In examples where the service provider of FIG. 8 has its own cryptocurrency assets, cryptocurrency transferred in a transaction (e.g., data with address provided for receipt of transaction and a balance of cryptocurrency transferred in the transaction) can be stored in the asset wallet 910. In at least one example, the service provider of FIG. 8 can credit the asset ledger 934 of the user. Additionally, while the service provider of FIG. 8 recognizes that the user retains the value of the transferred cryptocurrency through crediting the asset ledger 934, any person that inspects the blockchain will see the cryptocurrency as having been transferred to the service provider of FIG. 8. In some examples, the asset wallet 910 can be associated with many different addresses. In such examples, any person that inspects the blockchain may not easily associate all cryptocurrency stored in asset wallet 910 as belonging to the same entity. It is this presence of a private ledger that is used for real-time transactions and maintained by the service provider of FIG. 8, combined with updates to the public ledger at other times, that allows for extremely fast transactions using cryptocurrency to be achieved. In some examples, the “private ledger” can refer to the asset ledger 910, which in some examples, can utilize the private blockchain 919, as described herein. The “public ledger” can correspond to a public blockchain associated with the asset network.

In at least one example, a user's asset ledger 934, fiat currency ledger 936, or the like can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 934. In some examples, a user can receive fiat currency or another currency in the form of payment for a transaction with another user. In at least one example, at least a portion of such funds can be converted into cryptocurrency by the service provider of FIG. 8 and used to fund the asset ledger 934 of the user.

As addressed above, in some examples, users can also have other accounts maintained by the service provider of FIG. 8. For example, a user can also have an account in U.S. dollars, which can be tracked, for example, via the fiat currency ledger 936. Such an account can be funded by transferring money from a bank account at a third-party bank to an account maintained by the service provider of FIG. 8 as is conventionally known. In some examples, a user can receive fiat currency in the form of payment for a transaction with another user. In such examples, at least a portion of such funds can be used to fund the fiat currency ledger 936.

In some examples, a user can have one or more internal payment cards registered with the service provider of FIG. 8. Internal payment cards can be linked to one or more of the accounts associated with the user account 920. In some embodiments, options with respect to internal payment cards can be adjusted and managed using an application (e.g., the payment application 818).

In at least one example, as described above, each ledger can correspond to an account of the user that is managed by the service provider of FIG. 8. In at least one example, individual of the accounts can be associated with a wallet or a stored balance for use in payment transactions, peer-to-peer transactions, payroll payments, etc.

In at least one example, the user account 920 can be associated with an asset wallet 940. The asset wallet 940 of the user can be associated with account information that can be stored in the user account data 928 and, in some examples, can be associated with the user wallet key(s) 932. In at least one example, the asset wallet 940 can store data indicating an address provided for receipt of a cryptocurrency transaction. In at least one example, the balance of the asset wallet 940 can be based at least in part on a balance of the asset ledger 934. In at least one example, funds availed via the asset wallet 940 can be stored in the asset wallet 940 or the asset wallet 910. Funds availed via the asset wallet 910 can be tracked via the asset ledger 934. The asset wallet 940, however, can be associated with additional cryptocurrency funds.

In at least one example, when the service provider of FIG. 8 includes a private blockchain 919 for recording and validating cryptocurrency transactions, the asset wallet 940 can be used instead of, or in addition to, the asset ledger 934. For example, at least one example, a merchant can provide the address of the asset wallet 940 for receiving payments. In an example where a customer is paying in cryptocurrency and the customer has their own cryptocurrency wallet account associated with the service provider of FIG. 8, the customer can send a message signed by its private key including its wallet address (i.e., of the customer) and identifying the cryptocurrency and value to be transferred to the merchant's asset wallet 940. The service provider of FIG. 8 can complete the transaction by reducing the cryptocurrency balance in the customer's cryptocurrency wallet and increasing the cryptocurrency balance in the merchant's asset wallet 940. In addition to recording the transaction in the respective cryptocurrency wallets, the transaction can be recorded in the private blockchain 919 and the transaction can be confirmed. A user can perform a similar transaction with cryptocurrency in a peer-to-peer transaction as described above. In at least one example, the cryptocurrency wallet account 930 can be funded by a balance transfer from a third-party cryptocurrency wallet, as described above. Such a transaction can require a user to transfer an amount of cryptocurrency in a message signed by the user's private key to an address of the cryptocurrency wallet account 930. The transferred amount of cryptocurrency can then be within the cryptocurrency wallet account 930 for use in later transactions.

While the asset ledger 934 and/or asset wallet 940 are each described above with reference to cryptocurrency, the asset ledger 934 and/or asset wallet 940 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider of FIG. 8 is an aspect of the technology disclosed that enables technical advantages of increased processing speed and improved security.

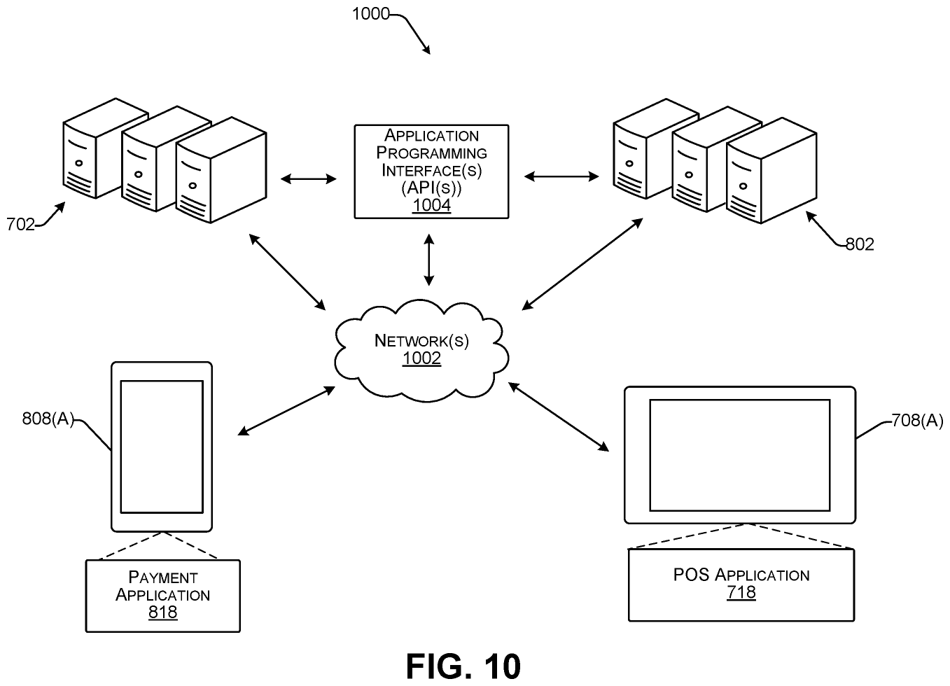

FIG. 10 illustrates an example environment 1000 wherein the environment 700 and the environment 800 can be integrated to enable payments at the point-of-sale using assets associated with user accounts in the peer-to-peer environment of FIG. 8. As illustrated, each of the components can communicate with one another via one or more networks 1002. In some examples, one or more APIs 1004 or other functional components can be used to facilitate such communication.

In at least one example, the example environment 1000 can enable contactless payments, via integration of peer-to-peer payment, or other payment making, platform(s) and payment processing platform(s), are described herein. For the purpose of FIG. 10, the environment 700 can refer to a payment processing platform and the environment 800 can refer to a peer-to-peer payment, or payment making, platform. In an example, such an integration can enable a customer to participate in a transaction via their own computing device instead of interacting with a merchant device of a merchant, such as the merchant device 708(A). In such an example, the POS application 718, associated with a payment processing platform and executable by the merchant device 708(A) of the merchant, can present a Quick Response (QR) code, or other code that can be used to identify a transaction (e.g., a transaction code), in association with a transaction between the customer and the merchant. The QR code, or other transaction code, can be provided to the POS application 718 via an API associated with the peer-to-peer payment platform. In an example, the customer can utilize their own computing device, such as the user device 808(A), to capture the QR code, or the other transaction code, and to provide an indication of the captured QR code, or other transaction code, to server(s) 702 and/or server(s) 802.

Based at least in part on the integration of the peer-to-peer payment platform and the payment processing platform (e.g., via the API), the server(s) 702 and/or 802 associated with each can exchange communications with each other—and with a payment application 818 associated with the peer-to-peer payment platform and/or the POS application 718—to process payment for the transaction using a peer-to-peer payment where the customer is a first “peer” and the merchant is a second “peer.” In at least one example, the peer-to-peer payment platform can transfer funds from an account of the customer, maintained by the peer-to-peer payment platform, to an account of the merchant, maintained by the payment processing platform, thereby facilitating a contactless (peer-to-peer) payment for the transaction. That is, based at least in part on receiving an indication of which payment method a user (e.g., customer or merchant) intends to use for a transaction, techniques described herein utilize an integration between a peer-to-peer payment platform and payment processing platform (which can be a first- or third-party integration) such that a QR code, or other transaction code, specific to the transaction can be used for providing transaction details, location details, customer details, or the like to a computing device of the customer, such as the user device 808(A), to enable a contactless (peer-to-peer) payment for the transaction.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 808(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 718 and the payment application 818, as described herein, can process a payment transaction by routing information input via the merchant application to the payment application for completing a “frictionless” payment. This can be referred to as “in-application payment.” In another example of “in-application payment,” the payment application described herein can be created or modified via a software developer kit (SDK) to enable in-application payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. In such a “scan to pay” example, a customer computing device, such as the user device 808(A), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc.

In an example, a customer can desire to purchase items from a merchant. When the customer approaches the merchant to check out, the merchant (e.g., a worker associated therewith) can add indications of the items to a virtual cart via the POS application 718, associated with a payment processing platform, on the merchant device 708(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, a display of the merchant device 708(A) can present a QR code, or other transaction code, that can be associated with a peer-to-peer payment platform. The customer can use a camera associated with the user device 808(A) to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction—between the customer computing device and the QR code—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As an additional or alternative example, a customer can desire to purchase items from a merchant. When the customer approaches the merchant to check out, the merchant (e.g., a worker associated therewith) can add indications of the items to a virtual cart via the POS application 718, associated with a payment processing platform, on the merchant device 708(A). In an example, the merchant can use the payment processing platform to process payments, and the payment processing platform can process payments for the merchant, as well as other merchants. That is, the payment processing platform can be an aggregator. After adding the first item, or otherwise providing an indication to start a transaction, the POS application 718 can cause a text message with a resource locator (e.g., uniform resource locator (URL)) that can be associated with a peer-to-peer payment platform to be sent to the user device 808(A). The customer can interact with the resource locator and, if the customer is already associated with the peer-to-peer payment platform (e.g., has an existing account, previously onboarded, etc.), the peer-to-peer payment platform can provide an indication of the interaction with the resource locator to the payment processing platform. This interaction—between the customer and the resource locator presented via the customer computing device—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. As described above, such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

The same or similar techniques can be applicable in online and/or ecommerce selling channels as well. In such an example, a QR code, or other transaction code, can be presented via an online store/ecommerce web page of a merchant. The customer can use a camera associated with a customer computing device, such as the user device 808(A), to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction—between the customer computing device and the QR code—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment can be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As described above, techniques described herein offer improvements to conventional payment technologies. In an example, techniques described herein can enable transaction data to be sent from a POS application 718 of a merchant device 708(A) at a brick-and-mortar store of a merchant to a payment application 818 of a user device 808(A) of a customer to enable the customer to participate in a transaction via their own computing device. For instance, in a “scan to pay” example as described above, based at least in part on capturing the QR code, or other transaction code, via the user device 808(A), the payment processing platform can provide transaction data to the peer-to-peer payment platform for presentation via the payment application 818 on the user device 808(A). In some examples, the customer can watch items being added to their cart (e.g., via a user interface presented via the payment application). As an item is added to a virtual cart by the merchant—via the POS application 718 on the merchant device 708(A) of the merchant—the customer can see the item in their virtual cart on their own computing device in near-real time. In another example, the peer-to-peer payment platform can analyze transaction data as it is received to determine whether an incentive (e.g., a discount, a loyalty reward, prioritized access or booking, etc.) is applicable to the transaction and can automatically apply the incentive or send a recommendation to the payment application 818 for presentation via a user interface associated therewith. In addition to enabling a customer to participate in a transaction during cart building, techniques described herein can enable a customer to complete a transaction, and in some examples, provide gratuity (i.e., a tip), feedback, loyalty information, or the like, via the user device 808(A) during or after payment of the transaction.

In some examples, based at least in part on capturing the QR code, or other transaction code, the payment processing platform can provide transaction data to the peer-to-peer payment platform for presentation via the payment application 818 on the computing device of the customer, such as the user device 808(A), to enable the customer to complete the transaction via their own computing device. In some examples, in response to receiving an indication that the QR code, or other transaction code, has been captured or otherwise interacted with via the customer computing device, the peer-to-peer payment platform can determine that the customer authorizes payment of the transaction using funds associated with a stored balance of the customer that is managed and/or maintained by the peer-to-peer payment platform. Such authorization can be implicit such that the interaction with the transaction code can imply authorization of the customer. In some examples, in response to receiving an indication that the QR code, or other transaction code, has been captured or otherwise interacted with via the customer computing device, the peer-to-peer payment platform can request authorization to process payment for the transaction using the funds associated with the stored balance and the customer can interact with the payment application to authorize the settlement of the transaction. A response to such a request can provide an express authorization of the customer. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the peer-to-peer payment platform can transfer funds from the stored balance of the customer to the payment processing platform. In at least one example, the payment processing platform can deposit the funds, or a portion thereof, into a stored balance of the merchant that is managed and/or maintained by the payment processing platform. That is, techniques described herein enable the peer-to-peer payment platform to transfer funds to the payment processing platform to settle payment of the transaction. In such an example, the payment processing platform can be a “peer” to the customer in a peer-to-peer transaction.

In some examples, techniques described herein can enable the customer to interact with the transaction after payment for the transaction has been settled. For example, in at least one example, the payment processing platform can cause a total amount of a transaction to be presented via a user interface associated with the payment application 818 such that the customer can provide gratuity, feedback, loyalty information, or the like, via an interaction with the user interface. In some examples, because the customer has already authorized payment via the peer-to-peer payment platform, if the customer inputs a tip, the peer-to-peer payment platform can transfer additional funds, associated with the tip, to the payment processing platform. This pre-authorization (or maintained authorization) of sorts can enable faster, more efficient payment processing when the tip is received. Further, the customer can provide feedback and/or loyalty information via the user interface presented by the payment application, which can be associated with the transaction.

As described above—and also below—techniques described herein enable contactless payments. That is, by integrating the payment processing platform with the peer-to-peer payment platform, merchants and customers can participate in transactions via their own computing devices without needing to touch, or otherwise be in contact, with one another. By moving aspects of a transaction that are traditionally performed on a computing device of a merchant to a computing device of a customer, customers can have more control over the transaction and can have more privacy. That is, customers can monitor items that are added to their cart to ensure accuracy. Further, customers can authorize payments, use rewards, claim incentives, add gratuity, or the like without being watched by the merchant or other customers.

In some examples, such as when the QR code, or other transaction code, is captured by the computing device of the customer prior to a payment selection user interface being presented via the POS application 718, payment for the transaction can be pre-authorized such that when the time comes to complete the transaction, neither the payment processing platform nor the peer-to-peer payment platform need to re-authorize payment at that time. That is, techniques described herein can enable faster, more efficient transactions. Further, in some examples, when a customer adds a tip after payment for a transaction has been settled, in some examples, because the peer-to-peer payment platform has already been authorized, the peer-to-peer payment platform and the payment processing platform may not need to obtain another authorization to settle funds associated with the tip. That is, in such examples, fewer data transmissions are required and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 818 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, instead of scanning, capturing, or otherwise interacting with a QR code or transaction code, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. For example, based at least in part on detecting a dip, tap, swipe, or the like, the payment processing platform can associate a customer with a transaction and provide at least a portion of transaction data associated with the transaction to a customer computing device associated therewith. In some examples, the payment instrument can be associated with the peer-to-peer payment platform as described herein (e.g., a debit card linked to a stored balance of a customer) such that when the payment instrument is caused to interact with a payment reader, the payment processing platform can exchange communications with the peer-to-peer payment platform to authorize payment for a transaction and/or provision associated transaction data to a computing device of the customer associated with the transaction.

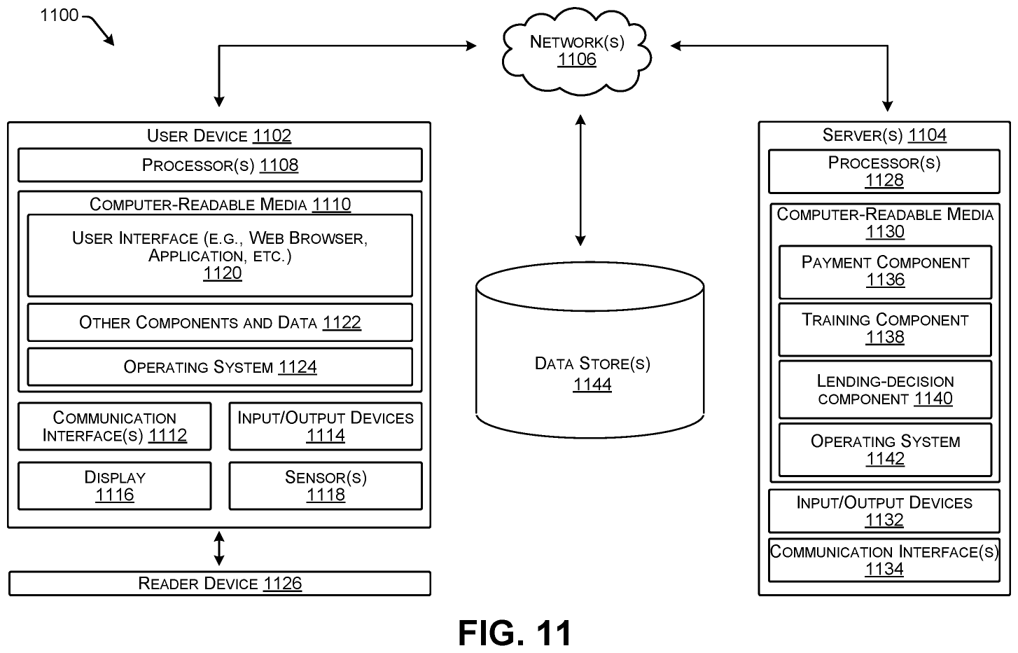

FIG. 11 depicts an illustrative block diagram illustrating a system 1100 for performing techniques described herein. The system 1100 includes a user device 1102, that communicates with server computing device(s) (e.g., server(s) 1104) via network(s) 1106 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1102 is illustrated, in additional or alternate examples, the system 1100 can have multiple user devices, as described above with reference to FIG. 6.

In at least one example, the user device 1102 can be any suitable type of computing device, e.g., portable, semi-portable, semi-stationary, or stationary. Some examples of the user device 1102 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. That is, the user device 1102 can be any computing device capable of sending communications and performing the functions according to the techniques described herein. The user device 1102 can include devices, e.g., payment card readers, or components capable of accepting payments, as described below.

In the illustrated example, the user device 1102 includes one or more processors 1108, one or more computer-readable media 1110, one or more communication interface(s) 1112, one or more input/output (I/O) devices 1114, a display 1116, and sensor(s) 1118.

In at least one example, each processor 1108 can itself comprise one or more processors or processing cores. For example, the processor(s) 1108 can be implemented as one or more microprocessors, microcomputers, microcontrollers, digital signal processors, central processing units, state machines, logic circuitries, and/or any devices that manipulate signals based on operational instructions. In some examples, the processor(s) 1108 can be one or more hardware processors and/or logic circuits of any suitable type specifically programmed or configured to execute the algorithms and processes described herein. The processor(s) 1108 can be configured to fetch and execute computer-readable processor-executable instructions stored in the computer-readable media 1110.

Depending on the configuration of the user device 1102, the computer-readable media 1110 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 1110 can include, but is not limited to, RAM, ROM, EEPROM, flash memory, solid-state storage, magnetic disk storage, optical storage, and/or other computer-readable media technology. Further, in some examples, the user device 1102 can access external storage, such as RAID storage systems, storage arrays, network attached storage, storage area networks, cloud storage, or any other medium that can be used to store information and that can be accessed by the processor(s) 1108 directly or through another computing device or network. Accordingly, the computer-readable media 1110 can be computer storage media able to store instructions, components or components that can be executed by the processor(s) 1108. Further, when mentioned, non-transitory computer-readable media exclude media such as energy, carrier signals, electromagnetic waves, and signals per se.

The computer-readable media 1110 can be used to store and maintain any number of functional components that are executable by the processor(s) 1108. In some implementations, these functional components comprise instructions or programs that are executable by the processor(s) 1108 and that, when executed, implement operational logic for performing the actions and services attributed above to the user device 1102. Functional components stored in the computer-readable media 1110 can include a user interface 1120 to enable users to interact with the user device 1102, and thus the server(s) 1104 and/or other networked devices. In at least one example, the user interface 1120 can be presented via a web browser, or the like. In other examples, the user interface 1120 can be presented via an application, such as a mobile application or desktop application, which can be provided by a service provider 612 associated with the server(s) 1104, or which can be an otherwise dedicated application. In some examples, the user interface 1120 can be the interfaces described above, such as the GUIs 300, 400, or the like. In at least one example, a user can interact with the user interface via touch input, spoken input, gesture, or any other type of input. The word “input” is also used to describe “contextual” input that may not be directly provided by the user via the user interface 1120. For example, user's interactions with the user interface 1120 are analyzed using, e.g., natural language processing techniques, to determine context or intent of the user, which may be treated in a manner similar to “direct” user input.

Depending on the type of the user device 1102, the computer-readable media 1110 can also optionally include other functional components and data, such as other components and data 1122, which can include programs, drivers, etc., and the data used or generated by the functional components. In addition, the computer-readable media 1110 can also store data, data structures and the like, that are used by the functional components. Further, the user device 1102 can include many other logical, programmatic and physical components, of which those described are merely examples that are related to the discussion herein.

In at least one example, the computer-readable media 1110 can include additional functional components, such as an operating system 1124 for controlling and managing various functions of the user device 1102 and for enabling basic user interactions.

The communication interface(s) 1112 can include one or more interfaces and hardware components for enabling communication with various other devices, such as over the network(s) 1106 or directly. For example, communication interface(s) 1112 can enable communication through one or more network(s) 1106, which can include, but are not limited any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1106 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1102 can further include one or more input/output (I/O) devices 1114. The I/O devices 1114 can include speakers, a microphone, a camera, and various user controls (e.g., buttons, a joystick, a keyboard, a keypad, etc.), a haptic output device, and so forth. The I/O devices 1114 can also include attachments that leverage the accessories (audio-jack, USB-C, Bluetooth, etc.) to connect with the user device 1102.

In at least one example, user device 1102 can include a display 1116. Depending on the type of computing device(s) used as the user device 1102, the display 1116 can employ any suitable display technology. For example, the display 1116 can be a liquid crystal display, a plasma display, a light emitting diode display, an OLED (organic light-emitting diode) display, an electronic paper display, or any other suitable type of display able to present digital content thereon. In at least one example, the display 1116 can be an augmented reality display, a virtually reality display, or any other display able to present and/or project digital content. In some examples, the display 1116 can have a touch sensor associated with the display 1116 to provide a touchscreen display configured to receive touch inputs for enabling interaction with a graphic interface presented on the display 1116. Accordingly, implementations herein are not limited to any particular display technology. Alternatively, in some examples, the user device 1102 may not include the display 1116, and information can be presented by other means, such as aurally, haptically, etc.

In addition, the user device 1102 can include sensor(s) 1118. The sensor(s) 1118 can include a GPS device able to indicate location information. Further, the sensor(s) 1118 can include, but are not limited to, an accelerometer, gyroscope, compass, proximity sensor, camera, microphone, and/or a switch.

In some example, the GPS device can be used to identify a location of a user. In at least one example, the location of the user can be used by the service provider 612, described above, to provide one or more services. That is, in some examples, the service provider 612 can implement geofencing to provide particular services to users. As an example, with a lending service, location can be used to confirm that a stated purpose of a loan corresponds to evidence of use (e.g., Is the user using the loan consistent with what he or she said he or she was going to use it for?). Furthermore, in some examples, location can be used for payroll purposes. As an example, if a contractor completes a project, the contractor can provide a geo-tagged image (e.g., tagged based on location information availed by the GPS device). In some examples, location can be used for facilitating peer-to-peer payments between nearby users 614 and/or for sending users 614 notifications regarding available appointments with merchant(s) located proximate to the users 614. In at least one example, location can be used for taking payments from nearby customers when they leave a geofence, or location can be used to initiate an action responsive to users 614 enter a brick-and-mortar store of a merchant. Location can be used in additional or alternative ways as well.

Additionally, the user device 1102 can include various other components that are not shown, examples of which include removable storage, a power source, such as a battery and power control unit, a barcode scanner, a printer, a cash drawer, and so forth.

In addition, in some examples, the user device 1102 can include, be connectable to, or otherwise be coupled to a reader device 1126, for reading payment instruments and/or identifiers associated with payment objects. In some examples, as described above, the reader device 1126 can plug in to a port in the user device 1102, such as a microphone port, a headphone port, an audio-jack, a data port, or other suitable port. In additional or alternative examples, the reader device 1126 can be coupled to the user device 1102 via another wired or wireless connection, such as via a Bluetooth®, BLE, and so on. The reader device 1126 can include a read head for reading a magnetic strip of a payment card, and further can include encryption technology for encrypting the information read from the magnetic strip. Additionally or alternatively, the reader device 1126 can be an EMV payment reader, which in some examples, can be embedded in the user device 1102. Moreover, numerous other types of readers can be employed with the user device 1102 herein, depending on the type and configuration of the user device 1102.

The reader device 1126 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data off any payment instrument. Accordingly, the reader device 1126 may include hardware implementation, such as slots, magnetic tracks, and rails with one or more sensors or electrical contacts to facilitate detection and acceptance of a payment instrument. That is, the reader device 1126 may include hardware implementations to enable the reader device 1126 to interact with a payment instrument via a swipe (i.e., a card-present transaction where a customer slides a card having a magnetic strip through a payment reader that captures payment data contained in the magnetic strip), a dip (i.e., a card-present transaction where a customer inserts a card having an embedded microchip (i.e., chip) into a payment reader first until the payment reader prompts the customer to remove the card), or a tap (i.e., a card-present transaction where a customer may tap or hover his or her electronic device such as a smart phone running a payment application over a payment reader to complete a transaction via short-range communication) to obtain payment data associated with a customer. Additionally or optionally, the reader device 1126 may also include a biometric sensor to receive and process biometric characteristics and process them as payment instruments, given that such biometric characteristics are registered with the payment service system 100 and connected to a financial account with a bank server.

The reader device 1126 may include processing unit(s), computer-readable media, a reader chip, a transaction chip, a timer, a clock, a network interface, a power supply, and so on. The processing unit(s) of the reader device 1126 may execute one or more components and/or processes to cause the reader device 1126 to perform a variety of functions, as set forth above and explained in further detail in the following disclosure. In some examples, the processing unit(s) may include a central processing unit (CPU), a graphics processing unit (GPU), a CPU and a GPU, or processing units or components known in the art. Additionally, each of the processing unit(s) may possess its own local memory, which also may store program components, program data, and/or one or more operating systems. Depending on the exact configuration and type of the reader device 1126, the computer-readable media may include volatile memory (such as RAM), non-volatile memory (such as ROM, flash memory, miniature hard drive, memory card, or the like), or some combination thereof. In at least one example, the computer-readable media of the reader device 1126 may include at least one component for performing various functions as described herein.

The reader chip may perform functionalities to control the operations and processing of the reader device 1126. That is, the reader chip may perform functionalities to control payment interfaces (e.g., a contactless interface, a contact interface, etc.), a wireless communication interface, a wired interface, a user interface (e.g., a signal condition device (FPGA)), etc. Additionally, the reader chip may perform functionality to control the timer, which may provide a timer signal indicating an amount of time that has lapsed following a particular event (e.g., an interaction, a power-down event, etc.). Moreover, the reader chip may perform functionality to control the clock 1112, which may provide a clock signal indicating a time. Furthermore, the reader chip may perform functionality to control the network interface, which may interface with the network(s) 1106, as described below.

Additionally, the reader chip may perform functionality to control the power supply. The power supply may include one or more power supplies such as a physical connection to AC power or a battery. Power supply may include power conversion circuitry for converting AC power and generating a plurality of DC voltages for use by components of reader device 1126. When power supply includes a battery, the battery may be charged via a physical power connection, via inductive charging, or via any other suitable method.

The transaction chip may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. Additionally, the transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While, the user device 1102, which can be a POS terminal, and the reader device 1126 are shown as separate devices, in additional or alternative examples, the user device 1102 and the reader device 1126 can be part of a single device, which may be a battery-operated device. In such an example, components of both the user device 1102 and the reader device 1126 may be associated with the single device. In some examples, the reader device 1126 can have a display integrated therewith, which can be in addition to (or as an alternative of) the display 1116 associated with the user device 1102.

The server(s) 1104 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1104 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 1104 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 1104 can include one or more processors 1128, one or more computer-readable media 1130, one or more I/O devices 1132, and one or more communication interfaces 1134. Each processor 1128 can be a single processing unit or a number of processing units, and can include single or multiple computing units or multiple processing cores. The processor(s) 1128 can be implemented as one or more microprocessors, microcomputers, microcontrollers, digital signal processors, central processing units, state machines, logic circuitries, and/or any devices that manipulate signals based on operational instructions. For example, the processor(s) 1128 can be one or more hardware processors and/or logic circuits of any suitable type specifically programmed or configured to execute the algorithms and processes described herein. The processor(s) 1128 can be configured to fetch and execute computer-readable instructions stored in the computer-readable media 1130, which can program the processor(s) 1128 to perform the functions described herein.

The computer-readable media 1130 can include volatile and nonvolatile memory and/or removable and non-removable media implemented in any type of technology for storage of information, such as computer-readable instructions, data structures, program components, or other data. Such computer-readable media 1130 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 1104, the computer-readable media 1130 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1130 can be used to store any number of functional components that are executable by the processor(s) 1128. In many implementations, these functional components comprise instructions or programs that are executable by the processors 1128 and that, when executed, specifically configure the one or more processors 1128 to perform the actions attributed above to the service provider and/or payment processing service. Functional components stored in the computer-readable media 1130 can optionally include a payment component 1136, a training component 1138, a lending-decision component 1140, and one or more other components and data. The payment component 1136, the training component 1138, and the lending-decision component 1140 may correspond, respectively, to the components 118, 120, and 122 described above.

The merchant component 1136 can be configured to receive transaction data from POS systems, such as the POS system 624 described above with reference to FIG. 6. The merchant component 1136 can transmit requests (e.g., authorization, capture, settlement, etc.) to payment service server computing device(s) to facilitate POS transactions between merchants and customers. The merchant component 1136 can communicate the successes or failures of the POS transactions to the POS systems.

The training component 1138 can be configured to train models using machine-learning mechanisms. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 1102 and/or the server(s) 1104 for use at a time after the data models have been trained (e.g., at runtime).

The one or more other components and data can include programs, drivers, etc., and the data used or generated by the functional components. Further, the server(s) 1104 can include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or nonvolatile memory for a computing device), hardware, or firmware (or any combination thereof) components. Modules are typically functional such that they that may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The computer-readable media 1130 can additionally include an operating system 1142 for controlling and managing various functions of the server(s) 1104.

The communication interface(s) 1134 can include one or more interfaces and hardware components for enabling communication with various other devices, such as over the network(s) 1106 or directly. For example, communication interface(s) 1134 can enable communication through one or more network(s) 1106, which can include, but are not limited any type of network known in the art, such as a local area network or a wide area network, such as the Internet, and can include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, network(s) 1102 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

The server(s) 1104 can further be equipped with various I/O devices 1132. Such I/O devices 1132 can include a display, various user interface controls (e.g., buttons, joystick, keyboard, mouse, touch screen, biometric or sensory input devices, etc.), audio speakers, connection ports and so forth.

In at least one example, the system 1100 can include a datastore 1144 that can be configured to store data that is accessible, manageable, and updatable. In some examples, the datastore 1144 can be integrated with the user device 1102 and/or the server(s) 1104. In other examples, as shown in FIG. 11, the datastore 1144 can be located remotely from the server(s) 1104 and can be accessible to the server(s) 1104. The datastore 1144 can comprise multiple databases and/or servers connected locally and/or remotely via the network(s) 1106.

In at least one example, the datastore 1144 can store user profiles, which can include merchant profiles, customer profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider 612.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc.

In at least one example, the account(s) 118, described above with reference to FIG. 1, can include or be associated with the merchant profiles and/or customer profiles described above.

Furthermore, in at least one example, the datastore 1144 can store inventory database(s) and/or catalog database(s). As described above, an inventory can store data associated with a quantity of each item that a merchant has available to the merchant. Furthermore, a catalog can store data associated with items that a merchant has available for acquisition. The datastore 1144 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

### Example Clauses

1. A method comprising: receiving, from a first computing device, a first set of inputs corresponding to an authenticated user; deriving a first set of metrics defining a behavioral model from the first set of inputs, the first set of metrics unique to the authenticated user; receiving, from a second computing device, a second set of inputs corresponding to a second user; deriving a second set of metrics from the second set of inputs; comparing the first set of metrics with the second set of metrics; determining that the second set of metrics does not substantially correspond with the first set of metrics; identifying a deviation from the behavioral model for the authenticated user; and transmitting a communication to the second computing device to deny authentication to the second user.

2. The method of clause 1, wherein the first metrics include one or more of: voice data captured by a sensor; location data captured by the sensor; a radius of a finger captured by the sensor; a tap speed of the finger captured by the sensor; an interval of time between taps on captured by the sensor; a swipe speed of the finger captured by the sensor; or an amount of finger pressure captured by the sensor.

3. The method of clause 1, wherein the communication comprises a first communication, and further comprising: determining context data associated with the second set of inputs; determining that the deviation is attributable to the context data; and transmitting a second communication to the second computing device to approve authentication of the second user.

4. The method of clause 1 further comprising sending another communication to a computing device associated with the authenticated user and to a merchant device associated with a merchant account indicating a fraudulent authentication attempt.

5. The method of clause 1, further comprising: receiving, from a third computing device, a third set of inputs; deriving a third set of metrics from the third set of inputs; determining that the third set of metrics substantially correspond to the first set of metrics; and updating the behavioral model using the third set of metrics.

6. A method comprising: receiving input data from a computing device that includes a data capturing component; receiving, from the computing device, sensor data representing one or more characteristics associated with an interaction between a user and the data capturing component while the input data is being captured; authenticating an account associated with the user based at least in part on the input data and the one or more characteristics; and sending, to the computing device, an indication that the account of the user has been authenticated.

7. The method of clause 6, wherein the sensor data comprises first sensor data and the method further comprises: receiving, prior to the receiving of the input data and the first sensor data, (i) an additional instance of the input data and (ii) second sensor data representing one or more characteristics associated with an interaction between the user and the data capturing component while the additional instance of the input data is being captured; defining a behavioral model from the second sensor data, the behavioral model being unique to the authenticated user; and wherein the authenticating comprises authenticating the account associated with the user at least partly by inputting data generated from the second sensor data into the behavioral model.

8. The method of clause 6, wherein the one or more characteristics comprise at least one of: voice data captured by the data capturing component; location data captured by the data capturing component; a radius of a finger captured by the data capturing component; a tap speed of the finger captured by the data capturing component; an interval of time between taps on captured by the data capturing component; a swipe speed of the finger captured by the data capturing component; or an amount of finger pressure captured by the data capturing component.

9. The method of clause 6, further comprising: generating, at least partly prior to the receiving of the input data, first signature data using previously received sensor data associated with the account of the user; storing the first signature data; generating second signature data using the sensor data representing the one or more characteristics associated with the interaction between the user and the data capturing component while the input data is being captured; comparing the second signature data to the first signature data to determine a similarity score indicating a degree of similarity; and determining that the similarity score is greater than a threshold similarity score; and wherein the authenticating comprises authenticating the account of the user based at least in part on the determining that the similarity score is greater than the threshold similarity score.

10. The method of clause 6, further comprising: generating signature data using the sensor data representing the one or more characteristics associated with the interaction between the user and the data capturing component while the input data is being captured; inputting the signature data into a model trained at least partly using previously received sensor data associated with the account associated with the user; and receiving, as output of the trained model, an indication that the signature data corresponds to the account associated with the user; and wherein the authenticating comprises authenticating the account of the user based at least in part on the receiving of the output.

11. The method of clause 6, wherein the computing device comprises a first computing device, and further comprising: receiving, from a second computing device, an additional instance of the input data; receiving, from the second computing device, sensor data associated with the additional instance of the input data; determining that the account associated with the user has not been authenticated based at least in part on the sensor data associated with the additional instance of the input data; sending, to the second computing device, an indication that the account of the user has not been authenticated; determining context data associated with the additional instance of the input data; determining, based at least in part on the context data, to authenticate the account associated with the user; and transmitting an indication to the second computing device that the account associated with the user has been authenticated.

12. The method of clause 11, further comprising determining that the additional instance of the input data comprises remote-access input provided to the second computing device from a third computing device that is remote from the second computing device.

13. The method of clause 11, further comprising determining that the sensor data has been not been generated based on an interaction between a data capturing component of the second computing device and a user of the second computing device.

14. A system comprising: one or more processors; and one or more non-transitory computer-readable media storing instructions that, when executed by one or more processors, cause the one or more processors to perform operations comprising: receiving input data from a computing device that includes a data capturing component; receiving, from the computing device, sensor data representing one or more characteristics associated with an interaction between a user and the data capturing component while the input data is being captured; authenticating an account associated with the user based at least in part on the input data and the one or more characteristics; and sending, to the computing device, an indication that the account of the user has been authenticated.

15. The system of clause 14, wherein the sensor data comprises first sensor data and the method further comprises: receiving, prior to the receiving of the input data and the first sensor data, (i) an additional instance of the input data and (ii) second sensor data representing one or more characteristics associated with an interaction between the user and the data capturing component while the additional instance of the input data is being captured; defining a behavioral model from the second sensor data, the behavioral model being unique to the authenticated user; and wherein the authenticating comprises authenticating the account associated with the user at least partly by inputting data generated from the second sensor data into the behavioral model.

16. The system of clause 14, wherein the one or more characteristics comprise at least one of: voice data captured by the data capturing component; location data captured by the data capturing component; a radius of a finger captured by the data capturing component; a tap speed of the finger captured by the data capturing component; an interval of time between taps on captured by the data capturing component; a swipe speed of the finger captured by the data capturing component; or an amount of finger pressure captured by the data capturing component.

17. The system of clause 14, wherein the one or more computer-readable media further store computer-executable instructions that, when executed, cause the one or more processors to perform acts comprising: generating, at least partly prior to the receiving of the input data, first signature data using previously received sensor data associated with the account of the user;

storing the first signature data; generating second signature data using the sensor data representing the one or more characteristics associated with the interaction between the user and the data capturing component while the input data is being captured; comparing the second signature data to the first signature data to determine a similarity score indicating a degree of similarity; and determining that the similarity score is greater than a threshold similarity score; and wherein the authenticating comprises authenticating the account of the user based at least in part on the determining that the similarity score is greater than the threshold similarity score.

18. The system of clause 14, wherein the one or more computer-readable media further store computer-executable instructions that, when executed, cause the one or more processors to perform acts comprising: generating signature data using the sensor data representing the one or more characteristics associated with the interaction between the user and the data capturing component while the input data is being captured; inputting the signature data into a model trained at least partly using previously received sensor data associated with the account associated with the user; and receiving, as output of the trained model, an indication that the signature data corresponds to the account associated with the user; and wherein the authenticating comprises authenticating the account of the user based at least in part on the receiving of the output.

19. The system of clause 14, wherein the computing device comprises a first computing device, and the one or more computer-readable media further store computer-executable instructions that, when executed, cause the one or more processors to perform acts comprising: receiving, from a second computing device, an additional instance of the input data; receiving, from the second computing device, sensor data associated with the additional instance of the input data; determining that the account associated with the user has not been authenticated based at least in part on the sensor data associated with the additional instance of the input data; sending, to the second computing device, an indication that the account of the user has not been authenticated; determining context data associated with the additional instance of the input data; determining, based at least in part on the context data, to authenticate the account associated with the user; and transmitting an indication to the second computing device that the account associated with the user has been authenticated.

20. The system of clause 18, wherein the one or more computer-readable media further store computer-executable instructions that, when executed, cause the one or more processors to perform acts comprising at least one of: determining that the additional instance of the input data comprises remote-access input provided to the second computing device from a third computing device that is remote from the second computing device; or determining that the touch data has been not been generated based on a physical interaction between a touchscreen display of the second computing device and a user of the second computing device.

1. A method comprising:
receiving, from a first computing device, a first set of inputs corresponding to an authenticated user;
deriving a first set of metrics defining a behavioral model from the first set of inputs, the first set of metrics unique to the authenticated user, wherein the first set of inputs comprises a first form of authentication for the authenticated user and the first set of metrics comprises a second form of authentication for the authenticated user;
receiving, from a second computing device, a second set of inputs corresponding to a second user;
deriving a second set of metrics from the second set of inputs;
comparing the first set of metrics with the second set of metrics;
determining that the second set of metrics does not substantially correspond with the first set of metrics;
identifying a deviation from the behavioral model for the authenticated user; and
transmitting a communication to the second computing device to deny authentication to the second user.

2. The method of claim 1, wherein the first set of metrics include one or more of: voice data captured by a sensor; location data captured by the sensor; a radius of a finger captured by the sensor; a tap speed of the finger captured by the sensor; an interval of time between taps on captured by the sensor; a swipe speed of the finger captured by the sensor; or an amount of finger pressure captured by the sensor.

3. The method of claim 1, wherein the communication comprises a first communication, and further comprising:
determining context data associated with the second set of inputs;
determining that the deviation is attributable to the context data; and
transmitting a second communication to the second computing device to approve authentication of the second user.

4. The method of claim 1 further comprising sending another communication to a computing device associated with the authenticated user and to a merchant device associated with a merchant account indicating a fraudulent authentication attempt.

5. The method of claim 1, further comprising:
receiving, from a third computing device, a third set of inputs;
deriving a third set of metrics from the third set of inputs;
determining that the third set of metrics substantially correspond to the first set of metrics; and
updating the behavioral model using the third set of metrics.

6. A method comprising:
receiving input data from a computing device that includes a data capturing component, wherein the input data comprises a first form of authentication;
receiving, from the computing device, sensor data representing one or more characteristics associated with an interaction between a user and the data capturing component while the input data is being captured, wherein the sensor data comprises a second form of authentication;
authenticating an account associated with the user based at least in part on the input data and the one or more characteristics; and
sending, to the computing device, an indication that the account of the user has been authenticated.

7. The method of claim 6, wherein the sensor data comprises first sensor data and the method further comprises:
receiving, prior to the receiving of the input data and the first sensor data, (i) an additional instance of the input data and (ii) second sensor data representing one or more characteristics associated with an interaction between the user and the data capturing component while the additional instance of the input data is being captured;
defining a behavioral model from the second sensor data, the behavioral model being unique to the user;
and wherein the authenticating comprises authenticating the account associated with the user at least partly by inputting data generated from the second sensor data into the behavioral model.

8. The method of claim 6, wherein the one or more characteristics comprise at least one of: voice data captured by the data capturing component; location data captured by the data capturing component; a radius of a finger captured by the data capturing component; a tap speed of the finger captured by the data capturing component; an interval of time between taps on captured by the data capturing component; a swipe speed of the finger captured by the data capturing component; or an amount of finger pressure captured by the data capturing component.

9. The method of claim 6, further comprising:
generating, at least partly prior to the receiving of the input data, first signature data using previously received sensor data associated with the account of the user;
storing the first signature data;
generating second signature data using the sensor data representing the one or more characteristics associated with the interaction between the user and the data capturing component while the input data is being captured;
comparing the second signature data to the first signature data to determine a similarity score indicating a degree of similarity; and
determining that the similarity score is greater than a threshold similarity score;
and wherein the authenticating comprises authenticating the account of the user based at least in part on the determining that the similarity score is greater than the threshold similarity score.

10. The method of claim 6, further comprising:
generating signature data using the sensor data representing the one or more characteristics associated with the interaction between the user and the data capturing component while the input data is being captured;
inputting the signature data into a model trained at least partly using previously received sensor data associated with the account associated with the user; and
receiving, as output of the trained model, an indication that the signature data corresponds to the account associated with the user;
and wherein the authenticating comprises authenticating the account of the user based at least in part on the receiving of the output.

11. The method of claim 6, wherein the computing device comprises a first computing device, and further comprising:
receiving, from a second computing device, an additional instance of the input data;
receiving, from the second computing device, sensor data associated with the additional instance of the input data;
determining that the account associated with the user has not been authenticated based at least in part on the sensor data associated with the additional instance of the input data;
sending, to the second computing device, an indication that the account of the user has not been authenticated;
determining context data associated with the additional instance of the input data;
determining, based at least in part on the context data, to authenticate the account associated with the user; and
transmitting an indication to the second computing device that the account associated with the user has been authenticated.

12. The method of claim 11, further comprising determining that the additional instance of the input data comprises remote-access input provided to the second computing device from a third computing device that is remote from the second computing device.

13. The method of claim 11, further comprising determining that the sensor data has not been generated based on an interaction between a data capturing component of the second computing device and a user of the second computing device.

14. A system comprising:
one or more processors; and
one or more non-transitory computer-readable media storing computer-executable instructions that, when executed by one or more processors, cause the one or more processors to perform acts comprising:
receiving input data from a computing device that includes a data capturing component, wherein the input data comprises a first form of authentication;
receiving, from the computing device, sensor data representing one or more characteristics associated with an interaction between a user and the data capturing component while the input data is being captured, wherein the sensor data comprises a second form of authentication;
authenticating an account associated with the user based at least in part on the input data and the one or more characteristics; and
sending, to the computing device, an indication that the account of the user has been authenticated.

15. The system of claim 14, wherein the sensor data comprises first sensor data and the acts further comprising:
receiving, prior to the receiving of the input data and the first sensor data, (i) an additional instance of the input data and (ii) second sensor data representing one or more characteristics associated with an interaction between the user and the data capturing component while the additional instance of the input data is being captured;
defining a behavioral model from the second sensor data, the behavioral model being unique to the user;
and wherein the authenticating comprises authenticating the account associated with the user at least partly by inputting data generated from the second sensor data into the behavioral model.

16. The system of claim 14, wherein the one or more characteristics comprise at least one of: voice data captured by the data capturing component; location data captured by the data capturing component; a radius of a finger captured by the data capturing component; a tap speed of the finger captured by the data capturing component; an interval of time between taps on captured by the data capturing component; a swipe speed of the finger captured by the data capturing component; or an amount of finger pressure captured by the data capturing component.

17. The system of claim 14, wherein the one or more non-transitory computer-readable media further store computer-executable instructions that, when executed, cause the one or more processors to perform acts comprising:
generating, at least partly prior to the receiving of the input data, first signature data using previously received sensor data associated with the account of the user;
storing the first signature data;
generating second signature data using the sensor data representing the one or more characteristics associated with the interaction between the user and the data capturing component while the input data is being captured;
comparing the second signature data to the first signature data to determine a similarity score indicating a degree of similarity; and
determining that the similarity score is greater than a threshold similarity score;
and wherein the authenticating comprises authenticating the account of the user based at least in part on the determining that the similarity score is greater than the threshold similarity score.

18. The system of claim 14, wherein the one or more non-transitory computer-readable media further store computer-executable instructions that, when executed, cause the one or more processors to perform acts comprising:
generating signature data using the sensor data representing the one or more characteristics associated with the interaction between the user and the data capturing component while the input data is being captured;
inputting the signature data into a model trained at least partly using previously received sensor data associated with the account associated with the user; and
receiving, as output of the trained model, an indication that the signature data corresponds to the account associated with the user;
and wherein the authenticating comprises authenticating the account of the user based at least in part on the receiving of the output.

19. The system of claim 14, wherein the computing device comprises a first computing device, and the one or more non-transitory computer-readable media further store computer-executable instructions that, when executed, cause the one or more processors to perform acts comprising:
receiving, from a second computing device, an additional instance of the input data;
receiving, from the second computing device, sensor data associated with the additional instance of the input data;
determining that the account associated with the user has not been authenticated based at least in part on the sensor data associated with the additional instance of the input data;
sending, to the second computing device, an indication that the account of the user has not been authenticated;
determining context data associated with the additional instance of the input data;
determining, based at least in part on the context data, to authenticate the account associated with the user; and
transmitting an indication to the second computing device that the account associated with the user has been authenticated.

20. The system of claim 19, wherein the one or more non-transitory computer-readable media further store computer-executable instructions that, when executed, cause the one or more processors to perform acts comprising at least one of:
determining that the additional instance of the input data comprises remote-access input provided to the second computing device from a third computing device that is remote from the second computing device; or
determining that the sensor data has not been generated based on a physical interaction between a touchscreen display of the second computing device and a user of the second computing device.
